(19) United States
(12) Patent Application Publication
(10) Pub. No.: US 2023/0132486 A1
(43) Pub. Date: May 4, 2023

(54) RECORDING MEDIUM AND EXTERIOR MEMBER

(71) Applicant: Sony Group Corporation, Tokyo (JP)

(72) Inventors: Aya TEJIMA, Tokyo (JP); Yuriko KAINO, Tokyo (JP); Ayumi KAI, Tokyo (JP); Ryota YAMANO, Tokyo (JP); Chiaki TAKAHASHI, Tokyo (JP); Kenichi KURIHARA, Tokyo (JP)

(21) Appl. No.: 17/910,417

(22) PCT Filed: Mar. 12, 2021
(86) PCT No.: PCT/JP2021/010175

§ 371 Date: Sep. 9, 2022

(30) Foreign Application Priority Data
Mar. 16, 2020 (JP) 2020-045189
Feb. 9, 2021 (JP) 2021-019349

(51) Int. Cl. B41M 5/333; B41M 5/337; B41M 5/42; B41M 5/46

(52) U.S. Cl. CPC B41M 5/333; B41M 5/337; B41M 5/42; B41M 5/46; B41M 2205/40

(57) ABSTRACT

A recording medium includes a support substrate and a recording layer provided on the support substrate. The recording layer contains a color-exhibiting compound having an electron-donating property, a color-developing agent having an electron-accepting property, and a matrix polymer. The color-developing agent contains a compound represented by a specific formula. The matrix polymer contains a polycarbonate resin.

### TECHNICAL FIELD

The present disclosure relates to a recording medium and an exterior member including the recording medium.

### BACKGROUND ART

In recent years, as an example of display media that are replacing printed matter, a recording medium in which information can be recorded by heat has been developed. In the recording medium, the stability of a non-recording part (hereinafter sometimes may be referred to as “background”) is required. PTL 1 describes that a bisurea compound represented by a specific formula is used as a color-developing agent in order to realize excellent stability of the background (ground color).

### CITATION LIST

### Patent Literature

[PTL 1]
JP H8-244355 A

### SUMMARY

### Technical Problem

However, the recording medium described in PTL 1 has insufficient light resistance of the background.

An object of the present disclosure is to provide a recording medium that can improve light resistance of the background and an exterior member including the recording medium.

### Solution to Problem

In order to solve the above problems, a first disclosure provides a recording medium including a support substrate and a recording layer provided on the support substrate, wherein the recording layer contains a color-exhibiting compound having an electron-donating property, a color-developing agent having an electron-accepting property, and a matrix polymer, wherein the color-developing agent contains at least one of compounds represented by the following

Formula (1A) and Formula (1B), and in which the matrix polymer contains a polycarbonate resin:

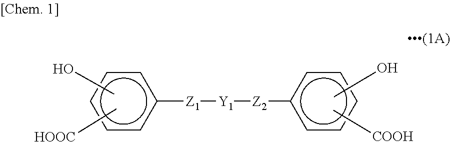

(where, in Formula (1A), Z₁ and Z₂ each independently represent a hydrogen-binding bonding group, and Y₁ represents a divalent group)

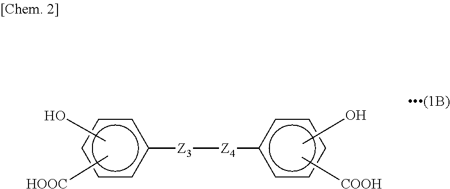

(where, in Formula (1B), Z₃ and Z₄ each independently represent a hydrogen-binding bonding group).

A second disclosure is an exterior member including the recording medium of the first disclosure.

### BRIEF DESCRIPTION OF DRAWINGS

FIG. 1 is a cross-sectional view showing an example of a configuration of a recording medium according to a first embodiment of the present disclosure.

FIG. 2 is a cross-sectional view showing an example of a configuration of a recording medium according to a second embodiment of the present disclosure.

FIG. 3 is a cross-sectional view showing an example of a configuration of a recording medium according to Modification Example 1 of the present disclosure.

FIG. 4A is a plan view showing a first example of a configuration of a recording medium according to Modification Example 3 of the present disclosure. FIG. 4B is a cross-sectional view taken along the line IVB-IVB in FIG. 4A.

FIG. 5A is a cross-sectional view showing a second example of a configuration of a recording medium according to Modification Example 3 of the present disclosure.

FIG. 5B is a cross-sectional view showing a third example of a configuration of a recording medium according to Modification Example 3 of the present disclosure.

FIG. 5C is a cross-sectional view showing a fourth example of a configuration of a recording medium according to Modification Example 3 of the present disclosure.

FIG. 5D is a cross-sectional view showing a fifth example of a configuration of a recording medium according to Modification Example 3 of the present disclosure.

FIG. 6A is a plan view showing an example of an appearance (surface side) of Application Example 1. FIG. 6B is a plan view showing an example of an appearance (back surface side) of Application Example 1.

FIG. 7A is a plan view showing an example of an appearance (surface side) of Application Example 2. FIG. 7B is a plan view showing an example of an appearance (back surface side) of Application Example 2.

FIG. 8A is a perspective view showing an example of an appearance (front surface side) of Application Example 3. FIG. 8B is a perspective view showing an example of an appearance (rear surface side) of Application Example 3.

FIG. 9A is a perspective view showing an example of an appearance (first surface side) of Application Example 4. FIG. 9B is a perspective view showing an example of an appearance (second surface side) of Application Example 4.

FIG. 10A is a plan view showing an example of an appearance (upper surface side) of Application Example 5. FIG. 10B is a plan view showing an example of an appearance (side surface side) of Application Example 5.

FIG. 11 is a plan view showing an example of an appearance of Application Example 6.

FIG. 12 is a perspective view showing an example of an appearance of Application Example 7.

FIG. 13A is a plan view showing an example of an appearance of Application Example 8. FIG. 13B is a cross-sectional view taken along the line XIIIB-XIIIB in FIG. 13A.

### DESCRIPTION OF EMBODIMENTS

Embodiments of the present disclosure will be described in the following order. Here, in all the drawings of the following embodiments, the same or corresponding parts will be denoted with the same reference numerals.
1 First Embodiment (Example of Recording Medium Including One Recording Layer)
1.1 Configuration of Recording Medium
1.2 Method of Producing Recording Medium
1.3 Method of Recording in Recording Medium
1.4 Operations and Effects
2 Second Embodiment (Example of Recording Medium Including Plurality of Recording Layers)
2.1 Configuration of Recording Medium
2.2 Method of Recording in Recording Medium
2.3 Operations and Effects
3 Modification Examples
3.1 Modification Example 1 (Example of Recording Medium in Which Multicolor Display is Possible with One Recording Layer)
3.2 Modification Example 2 (Example in Which Recording Layer is Formed by Mixing Plurality of Types of Color-Exhibiting Compounds)
3.3 Modification Example 3 (Example in Which Recording Layer is Provided on Part of Main Surface of Support Substrate)
4 Application Examples
5 Examples

### 1 First Embodiment

### 1.1 Configuration of Recording Medium

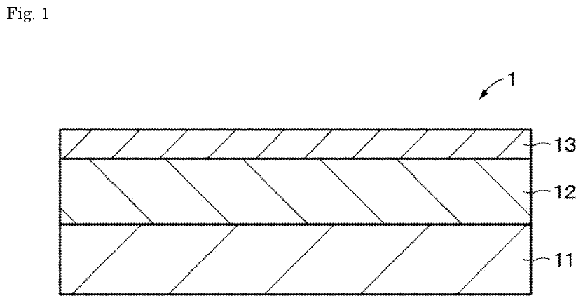

FIG. 1 shows a cross-sectional structure of a recording medium 1 according to a first embodiment of the present disclosure. The recording medium 1 is a recording medium whose coloring state can be changed by an external stimulus, and includes a support substrate 11 and a recording layer 12 provided on the support substrate 11. Here, FIG. 1 schematically shows the cross-sectional structure of the recording medium 1, which may differ from the actual size and shape.

### (Support Substrate)

The support substrate 11 is provided to support the recording layer 12. The support substrate 11 is preferably made of a material having excellent heat resistance and excellent dimensional stability in the planar direction. The support substrate 11 may have either light-transmitting or not-light-transmitting characteristics. The support substrate 11 may be, for example, a rigid substrate such as a wafer, or a flexible thin-layer glass, film, paper or the like. When a flexible substrate is used as the support substrate 11, a flexible (bendable) recording medium can be realized.

Examples of the material constituting the support substrate 11 include an inorganic material, a metal material and a polymer material such as plastic. Specific examples of inorganic materials include silicon (Si), silicon oxide (SiOₓ), silicon nitride (SiNₓ) and aluminum oxide (AlOₓ).

Silicon oxide includes glass, spin-on-glass (SOG) and the like. Examples of metal materials include aluminum (Al), nickel (Ni) and stainless steel, and examples of polymer materials include polycarbonate (PC), polyethylene terephthalate (PET), polyethylene naphthalate (PEN), polyethyl ether ketone (PEEK), polyvinyl chloride (PVC) and copolymers thereof.

Here, a reflective layer (not shown) may be provided on the upper surface or the lower surface of the support substrate 11, or the support substrate 11 itself may have a function as a reflective layer. Since the support substrate 11 has such a configuration, more vivid color display is possible.

### (Recording Layer)

The recording layer 12 has a configuration in which the coloring state can be changed by an external stimulus such a heating. The recording layer 12 in which stable recording is possible is made of a material that can control the color development state. Specifically, it includes a color-exhibiting compound having an electron-donating property, a color-developing agent having an electron-accepting property, a matrix polymer (binder), and a photothermal conversion material. The thickness of the recording layer 12 is, for example, 1 μm or more and 10 μm or less. Here, the photothermal conversion material is included in the recording layer 12 as necessary, and may not be included in the recording layer 12.

Examples of color-exhibiting compounds include leuco dyes. Examples of leuco dyes include existing dyes for heat-sensitive paper. Specifically, as an example, compounds represented by the following Formula (2) and containing a group having an electron-donating property in the molecule may be exemplified.

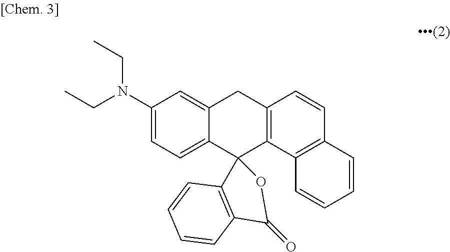 [SMILES: CCN(CC)c1ccc2c(c1)Cc1ccc3ccccc3c1C21OC(=O)c2ccccc21]

The color-exhibiting compound is not particularly limited, and can be appropriately selected depending on the purpose. Examples of specific color-exhibiting compounds include fluoran-based compounds, triphenyl methane phthalide-based compounds, azaphthalide-based compounds, phenothiazine-based compounds, leuco auramine-based compounds and indolinone phthalide-based compounds in addition to the compounds represented by Formula (2). In addition, for example, 2-anilino-3-methyl-6-diethylaminofluoran, 2-anilino-3-methyl-6-di(n-butylamino)fluoran, 2-anilino-3-methyl-6-(N-n-propyl-N-methylamino)fluoran, 2-anilino-3-methyl-6-(N-isopropyl-N-methylamino)fluoran, 2-anilino-3-methyl-6-(N-isobutyl-N-methylamino)fluoran, 2-anilino-3-methyl(N-n-amyl-N-methylamino)fluoran, 2-anilino-3-methyl-6-(N-sec-butyl-N-methylamino)fluoran, 2-anilino-3-methyl-6-(N-n-amyl-N-ethylamino)fluoran, 2-anilino-3-methyl-6-(N-iso-amyl-N-ethylamino)fluoran, 2-anilino-3-methyl-6-(N-n-propyl-N-isopropylamino)fluoran, 2-anilino-3-methyl-6-(N-cyclohexyl-N-methylamino)fluoran, 2-anilino-3-methyl-6-(N-ethyl-p-toluidino)fluoran, 2-anilino-3-methyl-6-(N-methyl-p-toluidino)fluoran, 2-(m-trichloromethylanilino)methyl-6-diethylaminofluoran, 2-(m-trifluloromethylanilino)-3-methyl diethylaminofluoran, 2-(m-trichloromethylanilino)-3-methyl-6-(N-cyclohexyl-N-methylamino)fluoran, 2-(2,4-dimethylanilino)-3-methyl-6-diethylaminofluoran, 2-(N-ethyl-p-toluidino)-3-methyl-6-(N-ethylanilino)fluoran, 2-(N-ethyl-p-toluidino)-3-methyl-6-(N-propyl-p-toluidino)fluoran, 2-anilino-6-(N-n-hexyl-N-ethylamino)fluoran, 2-(o-chloroanilino)-6-diethylaminofluoran, 2-(o-chloroanilino)-6-dibutylaminofluoran, 2-(m-trifloromethylanilino)-6-diethylaminofluoran, 2,3-dimethyl-6-dimethylaminofluoran, 3-methyl-6-(N-ethyl-p-toluidino)fluoran, 2-chloro-6-diethylaminofluoran, 2-bromo-6-diethylaminofluoran, 2-chloro-6-dipropylaminofluoran, 3-chloro-6-cyclohexylaminofluoran, 3-bromo-6-cyclohexylaminofluoran, 2-chloro-6-(N-ethyl-N-isoamylamino)fluoran, 2-chloro-3-methyl-6-diethylaminofluoran, 2-anilino-3-chloro-6-diethylaminofluoran, 2-(o-chloroanilino)-3-chloro-6-cyclohexylaminofluoran, 2-(m-trifloromethylanilino)-3-chloro-6-diethylaminofluoran, 2-(2,3-dichloroanilino)-3-chloro-6-diethylaminofluoran, 1,2-benzo-6-diethylaminofluoran, 3-diethylamino-6-(m-trifloromethylanilino)fluoran, 3-(1-ethyl-2-methylindole-3-yl)-3-(2-ethoxy-4-diethylaminophenyl)-4-azaphthalide, 3-(1-ethyl-2-methylindole-3-yl)-3-(2-ethoxy-4-diethylaminophenyl)-7-azaphthalide, 3-(1-octyl-2-methylindole-3-yl)-3-(2-ethoxy-4-diethylaminophenyl)-4-azaphthalide, 3-(1-ethyl-2-methylindole-3-yl)-3-(2-methyl-4-diethylaminophenyl)-4-azaphthalide, 3-(1-ethyl-2-methylindole-3-yl)-3-(2-methyl-4-diethylaminophenyl)-7-azaphthalide, 3-(1-ethyl-2-methylindole-3-yl)-3-(4-diethylaminophenyl)-4-azaphthalide, 3-(1-ethyl-2-methylindole-3-yl)-3-(4-N-n-amyl-N-methylaminophenyl)-4-azaphthalide, 3-(1-methyl-2-methylindole-3-yl)-3-(2-hexyloxy-4-diethylaminophenyl)-4-azaphthalide, 3,3-bis(2-ethoxy-4-diethylaminophenyl)-4-azaphthalide, 3,3-bis(2-ethoxy-4-diethylaminophenyl)-7-azaphthalide, 2-(p-acetylanilino)-6-(N-n-amyl-N-n-butylamino)fluoran, 2-benzylamino-6-(N-ethyl-p-toluidino)fluoran, 2-benzylamino-6-(N-methyl-2,4-dimethylamilino)fluoran, 2-benzylamino-6-(N-ethyl-2,4-dimethylanilino)fluoran, 2-benzylamino-6-(N-methyl-p-toluidino)fluoran, 2-benzylamino-6-(N-ethyl-p-toluidino)fluoran, 2-(di-p-methylbenzylamino)-6-(N-ethyl-p-toluidino)fluoran, 2-(α-phenylethylamino)-6-(N-ethyl-p-toluidino)fluoran, 2-methylamino-6-(N-methylanilino)fluoran, 2-methylamino-6-(N-ethylanilino)fluoran, 2-methylamino-6-(N-propylanilino)fluoran, 2-ethylamino-6-(N-methyl-p-toluidino)fluoran, 2-methylamino-6-(N-methyl-2,4-dimethylanilino)fluoran, 2-ethylamino-6-(N-ethyl-2,4-dimethylanilino)fluoran, 2-dimethylamino-6-(N-methylanilino)fluoran, 2-dimethylamino-6-(N-ethylanilino)fluoran, 2-diethylamino-6-(N-methyl-p-toluidino)fluoran, 2-diethylamino-6-(N-ethyl-p-toluidino)fluoran, 2-dipropylamino-6-(N-methylanilino)fluoran, 2-dipropylamino-6-(N-ethylanilino)fluoran, 2-amino-6-(N-methylanilino)fluoran, 2-amino-6-(N-ethylanilino)fluoran, 2-amino-6-(N-propylanilino)fluoran, 2-amino-6-(N-methyl-p-toluidino)fluoran, 2-amino-6-(N-ethyl-p-toluidino)fluoran, 2-amino-6-(N-propyl-p-toluidino)fluoran, 2-amino-6-(N-methyl-p-ethylanilino)fluoran, 2-amino-6-(N-ethyl-p-ethylanilino)fluoran, 2-amino-6-(N-propyl-p-ethylanilino)fluoran, 2-amino-6-(N-methyl-2,4-dimethylanilino)fluoran, 2-amino-6-(N-ethyl-2,4-dimethylanilino)fluoran, 2-amino-6-(N-propyl-2,4-dimethylanilino)fluoran, 2-amino-6-(N-methyl-p-chloroanilino)fluoran, 2-amino-6-(N-ethyl-p-chloroanilino)fluoran, 2-amino-6-(N-propyl-p-chloroanilino)fluoran, 1,2-benzo-6-(N-ethyl-N-isoamylamino)fluoran, 1,2-benzo-6-dibutylaminofluoran, 1,2-benzo-6-(N-methyl-N-cyclohexylamino)fluoran and 1,2-benzo-6-(N-ethyl-N-toluidino)fluoran may be exemplified.

The color-developing agent is, for example, for color development of a colorless color-exhibiting compound. The color-developing agent includes a bis(hydroxybenzoic acid) type compound containing a group having an electron-accepting property in the molecule. Specifically, the bis(hydroxybenzoic acid) type color-developing agent contains at least one of the compounds represented by the following Formula (1A) and Formula (1B):

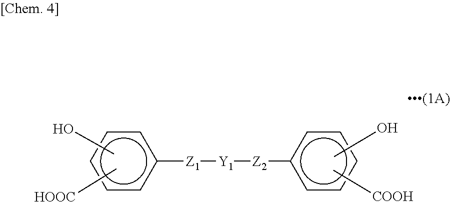

(where, in Formula (1A), Z₁ and Z₂ each independently represent a hydrogen-binding bonding group, and Y₁ represents a divalent group)

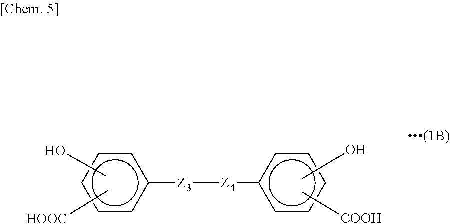

(where, in Formula (1B), Z₃ and Z₄ each independently represent a hydrogen-binding bonding group).

In Formulae (1A) and (1B), the bonding positions of a hydroxy group (—OH) and a carboxyl group (—COOH) with respect to benzene are not limited. That is, the bonding positions of a hydroxy group and a carboxyl group with respect to benzene may be any of an ortho position, a meta position and a para position. In Formulae (1A) and (1B), the bonding positions of a hydroxy group and a carboxyl group with respect to one benzene and the bonding positions of a hydroxy group and a carboxyl group with respect to the other benzene may be the same as or different from each other.

In Formula (1A), Z₁ and Z₂ each independently represent, for example, a urea bond (—NHCONH—), an amide bond (—NHCO—, —OCHN—) or a hydrazide bond (—NHCOCONH—). When Z₁ is an amide bond, a nitrogen atom contained in the amide bond may be bonded to benzene, and a carbon atom contained in the amide bond may be bonded to benzene. When Z₂ is an amide bond, a nitrogen atom contained in the amide bond may be bonded to benzene, and a carbon atom contained in the amide bond may be bonded to benzene.

In Formula (1B), Z₃ and Z₄ each independently represent, for example, a urea bond (—NHCONH—), an amide bond (—NHCO—, —OCHN—) or a hydrazide bond (—NHCOCONH—). When Z₃ is an amide bond, a nitrogen atom contained in the amide bond may be bonded to benzene, and a carbon atom contained in the amide bond may be bonded to benzene. When Z₄ is an amide bond, a nitrogen atom contained in the amide bond may be bonded to benzene, and a carbon atom contained in the amide bond may be bonded to benzene.

Y₁ may be a divalent group, and is not particularly limited, and for example, it may be a hydrocarbon group which may have a substituent. Some of carbon atoms of the hydrocarbon group (for example, some of carbon atoms contained in the main chain of the hydrocarbon group) may be substituted with an element such as oxygen. The hydrocarbon group is a general term for groups composed of carbon (C) and hydrogen (H), and may be a saturated hydrocarbon group or an unsaturated hydrocarbon group. Here, the saturated hydrocarbon group is an aliphatic hydrocarbon group having no carbon-carbon multiple bonds, and the unsaturated hydrocarbon group is an aliphatic hydrocarbon group having a carbon-carbon multiple bond (a carbon-carbon double bond or a carbon-carbon triple bond). In addition, the hydrocarbon group may be in the form of a chain or may contain one or two or more rings, but the chain form is preferable. The chain form may be a linear form or a branched form having one, two or more side chains, or the like. When the hydrocarbon group is in the form of a chain, since it is possible to reduce the melting point of the color-developing agent, the color-developing agent dissolves due to emitted laser light, which makes it easier for the color-exhibiting compound to develop the color. In order to reduce the melting point of the color-developing agent, a normal alkyl chain is particularly preferable among chain hydrocarbon groups.

The number of carbon atoms of the hydrocarbon group is, for example, 1 or more and 15 or less, 1 or more and 13 or less, 1 or more and 12 or less, 1 or more and 10 or less, 1 or more and 6 or less or 1 or more and 3 or less.

When Y₁ is a normal alkyl group, the number of carbon atoms of the normal alkyl group is preferably 8 or less, more preferably 6 or less, still more preferably 5 or less, and particularly preferably 3 or less in consideration of high-temperature storage stability. It is thought that, when the number of carbon atoms of the normal alkyl group is 8 or less, since the length of the normal alkyl group is short, thermal disturbance during high-temperature storage is unlikely to occur in the color-developing agent, and parts that have interacted with color-exhibiting compounds such as leuco dyes are unlikely to be detached during color development. Therefore, color-exhibiting compounds such as leuco dyes are less likely to be discolored during high-temperature storage so that the high-temperature storage stability is improved.

In addition, when Y₁ is a normal alkyl group, in consideration of different behaviors of even and odd numbers of carbon atoms (evenness of carbon number), the melting point of the color-developing agent having an odd number of carbon atoms of the normal alkyl group is generally likely to be lower than the melting point of the color-developing agent having an even number of carbon atoms of the normal alkyl group. Therefore, in order to improve color development characteristics, the number of carbon atoms of the normal alkyl group is preferably an odd number. In order to improve both high temperature storage characteristics and color development characteristics, the number of carbon atoms of the normal alkyl group is preferably an odd number of 7 or less, more preferably an odd number of 5 or less, and still more preferably an odd number of 3 or less.

Examples of substituents that the hydrocarbon group may have include a halogen group (for example, a fluorine group) and an alkyl group having a halogen group (for example, a fluorine group).

More specifically, the bis(hydroxybenzoic acid) type color-developing agent may contain at least one selected from the group consisting of compounds represented by the following Formulae (1-1) to (1-8).

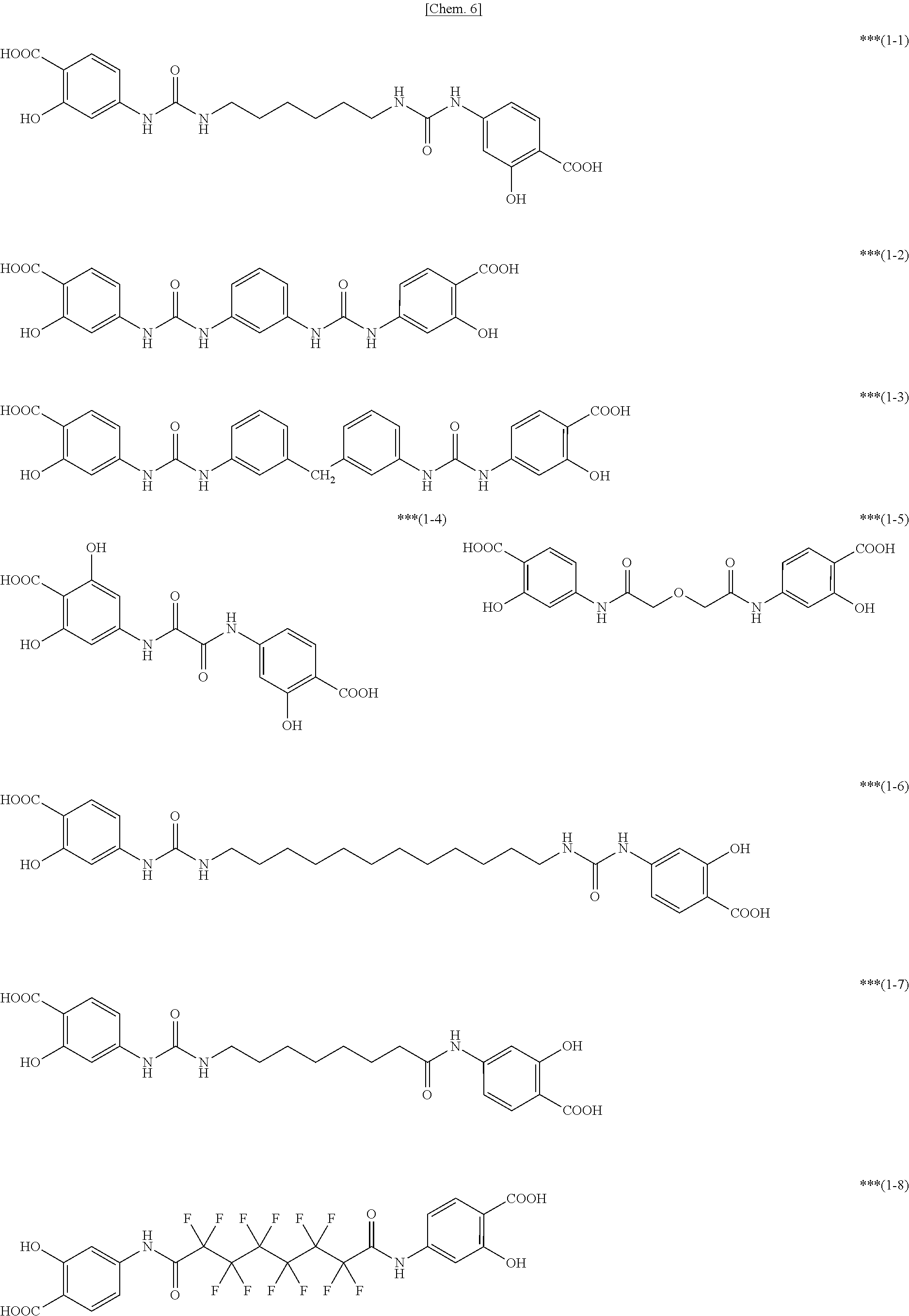

The bis(hydroxybenzoic acid) type color-developing agent may contain at least one selected from the group consisting of compounds represented by the following Formulae (1-9) to (1-19).

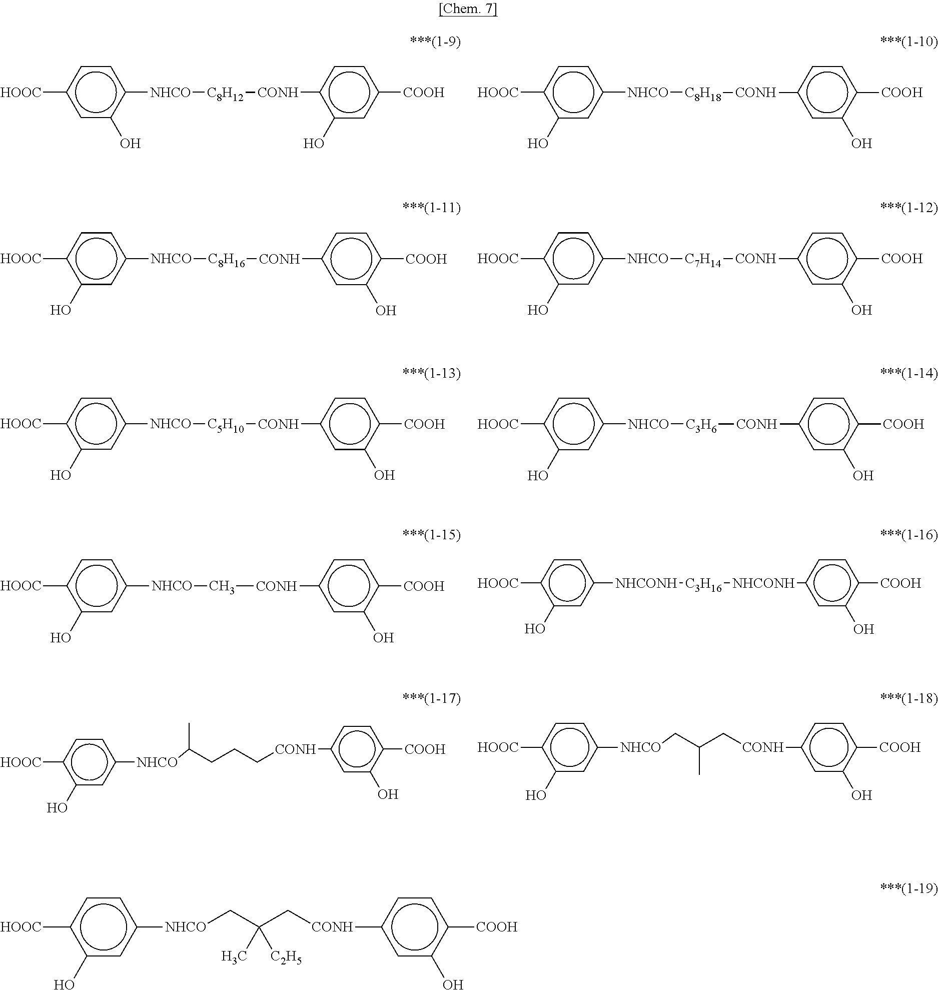

The bis(hydroxybenzoic acid) type color-developing agent may contain at least one selected from the group consisting of compounds represented by Formulae (1-1) to (1-19).

The photothermal conversion material absorbs, for example, light in a predetermined wavelength range in a near infrared light region and generates heat. As the photothermal conversion material, it is preferable to use, for example, a near infrared light absorbing dye having an absorption peak in a wavelength range of 700 nm or more and 2,000 nm or less and having almost no absorption in the visible region. Specifically, for example, a compound having a phthalocyanine framework (phthalocyanine dye), a compound having a squarylium framework (squarylium dye), and for example, an inorganic compound, may be exemplified. Examples of inorganic compounds include metal complexes such as dithio complexes, diimonium salts, aminium salts, and inorganic compounds. Examples of inorganic compounds include graphite, carbon black, metal powder particles, and metal oxides such as tricobalt tetroxide, iron oxide, chrome oxide, copper oxide, titanium black, and indium tin oxide (ITO), metal nitrides such as nobium nitride, metal carbides such as tantalum carbide, metal sulfide, and various magnetic powders. In addition, a compound having a cyanine framework having excellent light resistance and heat resistance (cyanine dye) may be used. Here, excellent light resistance means that the material does not decompose under a usage environment, for example, with light emitted from a fluorescent lamp. Excellent heat resistance means that, for example, when a film is formed together with a polymer material and stored, for example, at 150° C. for 30 minutes, the maximum absorption peak value of the absorption spectrum does not change by 20% or more. Examples of compounds having such a cyanine framework include those having, for example, at least one of a counter ion of any of SbF₆, PF₆, BF₄, ClO₄, CF₃SO₃ and (CF₃SO₃)₂N and a methine chain containing a 5-membered ring or a 6-membered ring in the molecule. Here, the compound having a cyanine framework used in the recording medium 1 according to the first embodiment preferably has both one of the above counter ions and a ring structure such as a 5-membered ring or a 6-membered ring in the methine chain, but if at least one of them is provided, sufficient light resistance and heat resistance are secured.

The matrix polymer is preferably one in which a color-exhibiting compound, a color-developing agent and a photothermal conversion material can be easily dispersed uniformly. The matrix polymer contains a polycarbonate resin. Here, the polycarbonate resin is a resin that may have a carbonate group (—O—(C═O)—O—) as a structural unit in at least a main chain. Therefore, the main chain may have a structural unit other than the carbonate group.

The recording layer 12 contains at least one of each of the color-exhibiting compounds, color-developing agents and the photothermal conversion materials. The color-exhibiting compound and the color-developing agent contained in the recording layer 12 are preferably contained, for example, at a weight ratio of 1:2 of the color-exhibiting compound: the color-developing agent. The photothermal conversion material changes according to the film thickness of the recording layer 12. In addition, the recording layer 12 may contain various additives, for example, a sensitizer and a UV absorbing material, in addition to the above materials.

The difference ΔT=T_{B}−T_{A} between the transmittance T_{A} of the recording medium 1 obtained after heating press is performed at 150° C. and the transmittance T_{B} of the recording medium 1 obtained before the heating press (where, the transmittances T_{A} and T_{B} are average transmittances in a wavelength band range of 1,000 nm or more and 1,100 nm or less) is preferably 1.0% or less, and more preferably 0.6% or less. If ΔT is 1.0 or less, the recording medium 1 can withstand heating press at 150° C. Here, “the recording medium 1 can withstand heating press” means that the change in the color of the recording medium 1 (transmittance change) according to heating press can be reduced. In addition, the “temperature during heating press” means the temperature of the surface of the plate used for heating press the recording medium 1 during heating press.

### (Protective Layer)

The recording medium 1 preferably further includes a protective layer 13 provided on the recording layer 12. The protective layer 13 is for protecting the surface of the recording layer 12, and is formed, for example, using at least one of a UV curable resin and a thermo-curable resin. The thickness of the protective layer 13 is, for example, 0.1 μm or more and 20 μm or less.

### 1.2 Method of Producing Recording Medium

The recording medium 1 according to the first embodiment can be produced using, for example, a coating method. Here, the production method to be described below is an example, and other methods may be used for production.

First, a matrix polymer is dissolved in a solvent (for example, methyl ethyl ketone). Next, a color-developing agent, a color-exhibiting compound and a photothermal conversion material are added to the solution and dispersed. Thereby, a coating material for forming a recording layer is obtained. Subsequently, the coating material for forming a recording layer is applied onto the support substrate 11, for example, to a thickness of 3 μm, and dried, for example, at 70° C., and the recording layer 12 is formed. Next, for example, an acrylic resin is applied onto the recording layer 12, for example, to a thickness of 10 μm, and then dried to form the protective layer 13. Accordingly, the recording medium 1 shown in FIG. 1 is completed.

Here, the recording layer 12 may be formed using a method other than the above coating method. For example, a layer formed by application to another substrate in advance may be attached onto the support substrate 11, for example, via an adhesive layer, to form the recording layer 12. Alternatively, the support substrate 11 may be immersed in a coating material to form the recording layer 12.

### 1.3 Method of Recording in Recording Medium

In the recording medium 1 according to the first embodiment, for example, recording can be performed as follows.

At a desired position of the recording layer 12, near infrared light whose wavelength and output are adjusted is emitted with, for example, a semiconductor laser. Thereby, the photothermal conversion material contained in the recording layer 12 generates heat, a color-developing reaction (color development reaction) occurs between the color-exhibiting compound and the color-developing agent, and the irradiated part develops color.

### 1.4 Operations and Effects

As described above, in the recording layer 12 of the recording medium 1 according to the first embodiment, the matrix polymer contains a polycarbonate resin. Accordingly, because the matrix polymer containing a polycarbonate resin does not easily generate an acid by photolysis, it is possible to prevent an acid thus generated from reacting with the color-exhibiting compound. Therefore, it is possible to prevent the development of color of the background (unrecorded part) of the recording medium 1. Therefore, it is possible to improve the light resistance of the background of the recording medium 1.

The color-developing agent contains at least one of the compounds represented by Formula (1A) and Formula (1B). Since the above compound is a compound having a strong acidity, it is difficult to separate the compound that has reacted with the color-exhibiting compound once. In addition, since the color-developing agents are likely to be solidified to some extent via hydrogen bonds, the stability of the color-developing agent in the recording layer 12 is improved. Therefore, it is possible to improve the storage stability of the recording medium 1. In addition, since the energy required to dissolve the color-developing agent in the recording layer 12 becomes large, the recording medium 1 can withstand high-temperature pressing (for example, high-temperature pressing at 150° C.). Here, “can withstand” means that the color change (transmittance change) due to high-temperature pressing can be minimized.

The matrix polymer of the recording layer 12 contains a polycarbonate resin having transparency. In addition to excellent transparency of the polycarbonate resin itself, because the compounds represented by Formula (1A) and Formula (1B) have an alkyl chain and a benzene ring in addition to the hydrogen bonding group in the molecule, they have a high compatibility with the matrix polymer. Therefore, it is easy to set the particle size to 1 μm or less during dispersion, and they are not easily visible during film formation. Therefore, it is possible to improve the transparency of the recording layer 12.

Next, a second embodiment and Modification Examples 1, 2, 3, and 4 of the present disclosure will be described. In the following, the same component as those in the first embodiment will be denoted with the same reference numerals, and descriptions thereof will be omitted appropriately.

### Second Embodiment

In the first embodiment, an example in which a recording medium includes a recording layer having a single-layer structure has been described. However, in the second embodiment, an example in which recording layers include the first layer to the nth layer containing color-exhibiting compounds having color development hues different from each other will be described.

### 2.1 Configuration of Recording Medium

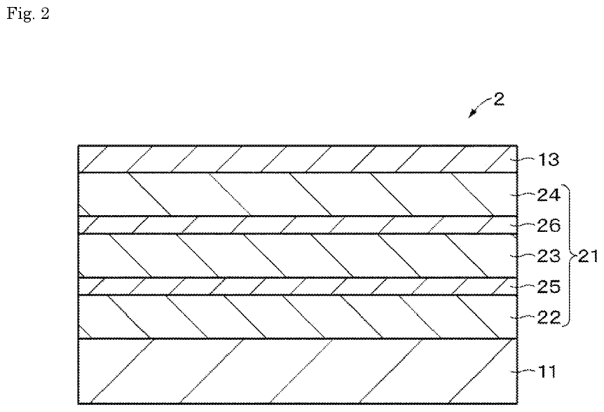

FIG. 2 shows a cross-sectional structure of a recording medium 2 according to the second embodiment of the present disclosure. The recording medium 2 is different from the recording medium 1 according to the first embodiment in that a recording layer 21 is provided in place of the recording layer 12 (refer to FIG. 1). The recording layer 21 includes, for example, three layers (a first layer 22, a second layer 23 and a third layer 24) that are laminated in that order, and insulation layers 25 and 26 are provided between the layers 22, 23, and 24. Here, FIG. 2 schematically shows a cross-sectional structure of the recording medium 2, which may differ from actual sizes and shapes.

The recording layer 21 has a configuration in which the coloring state can be changed by an external stimulus such as heating, and as described above, for example, it has a configuration in which the first layer 22, the second layer 23 and the third layer 24 are laminated in that order from the side of the support substrate 11. The first layer 22, the second layer 23 and the third layer 24 contain color-exhibiting compounds that exhibit different colors, color-developing agents corresponding to the color-exhibiting compounds, a matrix polymer, and photothermal conversion materials that absorb light in different wavelength ranges and generate heat.

As described above, for example, the color-developing agent is for color development of a colorless color-exhibiting compound. The color-developing agent contains the compound represented by Formula (1). As described above, the photothermal conversion material is selected from among, for example, compound having a phthalocyanine framework (phthalocyanine dye), a compound having a squarylium framework (squarylium dye), an inorganic compound and the like. In addition, as in the first embodiment, a compound having a cyanine framework having excellent light resistance and heat resistance (cyanine dye) may be used.

Specifically, the first layer 22 contains, for example, a color-exhibiting compound that develops the color cyan in a color development state, a color-developing agent corresponding thereto (at least one of the compounds represented by Formula (1A) and Formula (1B)), matrix polymer (polycarbonate resin) and a photothermal conversion material that absorbs infrared light having a wavelength Xi and generates heat. The second layer 23 contains, for example, a color-exhibiting compound that exhibits the color magenta in a color development state, a color-developing agent corresponding thereto (at least one of the compounds represented by Formula (1A) and Formula (1B)), a matrix polymer (polycarbonate resin) and a photothermal conversion material that absorbs infrared light having a wavelength λ₂ and generates heat. The third layer 24 contains, for example, a color-exhibiting compound that exhibits the color yellow in a color development state, a color-developing agent corresponding thereto (at least one of the compounds represented by Formula (1A) and Formula (1B)), a matrix polymer (polycarbonate resin) and a photothermal conversion material that absorbs infrared light having a wavelength λ₃ and generates heat. Thereby, the recording medium 2 in which multicolor display is possible can be obtained.

Here, as the photothermal conversion material, it is preferable to select a combination of materials having a narrow light absorption band in, for example, a wavelength range of 700 nm or more and 2,000 nm or less, and not overlapping with each other. Thereby, a desired layer among the first layer 22, the second layer 23 and the third layer 24 can be selectively color-developed.

The thickness of the first layer 22, the second layer 23 and the third layer 24 is preferably, for example, 1 μm or more and 20 μm or less, and more preferably, for example, 2 μm or more and 15 μm or less. This is because, if the thickness of the layers 22, 23, and 24 is less than 1 μm, there is a risk of a sufficient color development concentration not being obtained. In addition, this is because, if the thickness of each of the layers 22, 23, and 24 is thicker than 20 μm, the amount of heat used by each of the layers 22, 23, and 24 becomes large, and there is a risk of color development characteristics deteriorating.

In addition, as in the recording layer 12, the first layer 22, the second layer 23 and the third layer 24 may contain various additives, for example, a sensitizer and a UV absorbing material, in addition to the above material.

In addition, in the recording layer 21 in the second embodiment, the insulation layers 25 and 26 are provided between the first layer 22 and the second layer 23 and between the second layer 23 and the third layer 24, respectively. The insulation layers 25 and 26 are made of, for example, a general translucent polymer material. Examples of specific materials include polyvinyl chloride, polyvinyl acetate, vinyl chloride-vinyl acetate copolymers, ethyl cellulose, polystyrene, styrene-based copolymers, phenoxy resins, polyester, aromatic polyester, polyurethane, polycarbonate, polyacrylic acid ester, polymethacrylate, acrylic acid-based copolymers, maleic acid-based polymers, polyvinyl alcohols, modified polyvinyl alcohols, hydroxyethyl cellulose, carboxymethyl cellulose, and starch. Here, the insulation layers 25 and 26 may contain, for example, various additives such as a UV absorbent.

In addition, the insulation layers 25 and 26 may be formed using a translucent inorganic material. For example, it is preferable to use porous silica, alumina, titania, carbon, a complex thereof, or the like so that the thermal conductivity is low and a thermal insulation effect becomes strong. The insulation layers 25 and 26 can be formed by, for example, a sol-gel method.

The thickness of the insulation layers 25 and 26 is preferably, for example, 3 or more and 100 μm or less, and more preferably, for example, 5 μm or more and 50 μm or less. If the thickness of the insulation layers 25 and 26 is too thin, there is a risk of a sufficient thermal insulation effect not being obtained. On the other hand, if the thickness of the insulation layers 25 and 26 is too thick, there is a risk of the translucency decreasing. In addition, there is a risk of the bending resistance of the recording medium 2 decreasing and defects such as cracks easily occurring.

### 2.2 Method of Recording in Recording Medium

In the recording medium 2 according to the second embodiment, for example, recording can be performed as follows. Here, for the recording layer 21, an example in which the above first layer 22, second layer 23 and third layer 24 that exhibit the color cyan, the color magenta, and the color yellow, respectively, are laminated will be described.

Infrared light having an arbitrarily selected wavelength and output is emitted to an arbitrary part of the recording layer 21, for example, with a semiconductor laser or the like. Here, when the first layer 22 is made to develop a color, infrared light having a wavelength Xi is emitted to the first layer 22 with energy at which the first layer 22 reaches the color development temperature. Thereby, the photothermal conversion material contained in the first layer 22 generates heat, a color-developing reaction (color development reaction) occurs between the color-exhibiting compound and the color-developing agent, and the color cyan is developed in the irradiated part. Similarly, when the second layer 23 is made to develop a color, infrared light having a wavelength λ₂ is emitted to the second layer 23 with energy at which the second layer 23 reaches the color development temperature. When the third layer 24 is made to develop a color, infrared light having a wavelength λ₃ is emitted to the third layer 24 with energy at which the third layer 24 reaches the color development temperature. Thereby, the photothermal conversion materials contained in the second layer 23 and the third layer 24 generate heat, a color-developing reaction occurs between the color-exhibiting compound and the color-developing agent, and the color magenta and the color yellow are developed in the irradiated parts. In this manner, when infrared light having a corresponding wavelength is emitted to an arbitrary part, information (for example, full color image) can be recorded.

### 2.3 Operations and Effects

As described above, in the recording medium 2 according to the second embodiment, for example, three layers (the first layer 22, the second layer 23 and the third layer 24) including color-exhibiting compounds that exhibit the color yellow, the color magenta or the color cyan, a color-developing agent containing at least one of the compounds represented by Formula (1A) and Formula (1B), a matrix polymer containing a polycarbonate resin, and photothermal conversion materials having different absorption wavelengths are formed and laminated. Thereby, in a recording medium in which multicolor recording is possible, the same effects (light weather resistance, etc.) as in the above first embodiment can be obtained.

### 3. Modification Examples

### Modification Example 1

In the above second embodiment, a multi-layer structure in which, as the recording layer 21, layer exhibiting different colors (the first layer 22, the second layer 23 and the third layer 24) are formed and laminated has been exemplified. However, for example, a recording medium in which multicolor display is possible even with a single-layer structure can be realized.

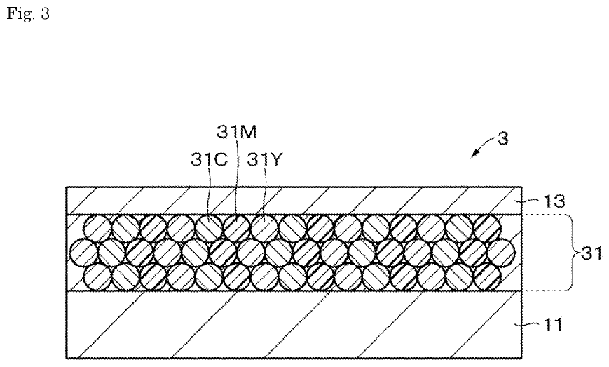

FIG. 3 is a cross-sectional view showing an example of a configuration of a recording medium 3 in which multicolor display is possible even with a single-layer structure. A recording layer 31 contains three types of microcapsules 31C, 31M, and 31Y that exhibit different colors in the color development state. The recording layer 31 may contain a first matrix polymer, as necessary. The three types of microcapsules 31C, 31M, and 31Y contain, for example, color-exhibiting compounds that exhibit different colors (for example, the color cyan (C), the color magenta (M) and the color yellow (Y)), color-developing agents corresponding to the color-exhibiting compounds (at least one of the compounds represented by Formula (1A) and Formula (1B)), photothermal conversion materials that absorb light in different wavelength ranges and generate heat, and a second matrix polymer. The second matrix polymer contains a polycarbonate resin. On the other hand, the first matrix polymer may or may not contain a polycarbonate resin. As the material of the microcapsule wall containing the above material, for example, it is preferable to use the material constituting the insulation layers 25 and 26.

### Modification Example 2

In the first embodiment and the second embodiment, an example in which the recording layer 12 and the recording layer 21 (the first layer 22, the second layer 23, and the third layer 24) are each formed using a single (one type) color-exhibiting compound is shown, but the present invention is not limited thereto. In the recording mediums 1 and 2 in the first and second embodiments, the recording layers 12 and 21 (the first layer 22, the second layer 23, and the third layer 24) may be formed by mixing a plurality of types of color-exhibiting compounds that exhibit different colors.

In the recording medium, it is difficult to reproduce Japan color CMY (cyan, magenta, and yellow) using a single color-exhibiting compound (leuco dye). In addition, since the photothermal conversion material has a slight color tone, the color tone of the recording layer slightly changes depending on the type and content of the photothermal conversion material. Developing a color-exhibiting compound for this slight change each time significantly reduces the production efficiency.

On the other hand, in this modification example, when the recording layer 12 and the recording layer 21 (the first layer 22, the second layer 23 and the third layer 24) are formed by mixing a plurality of types of color-exhibiting compounds, various colors including Japan color CMY can be reproduced. For example, the color cyan can be reproduced by mixing a color-exhibiting compound that exhibits the color blue and a color-exhibiting compound that exhibits the color green in a predetermined ratio. Magenta can be reproduced by mixing a color-exhibiting compound that exhibits red and a color-exhibiting compound that exhibits the color orange in a predetermined ratio.

Here, also in the recording medium 3 of Modification Example 1, the microcapsules 31C, 31M, and 31Y constituting the recording layer 31 may be formed using a plurality of types of color-exhibiting compounds.

### Modification Example 3

In the first embodiment and the second embodiment, an example in which the recording layer 12 and the recording layer 21 are provided over the entire one main surface of the support substrate 11 has been described, but the recording layer 12 and the recording layer 21 may be provided on a part of one main surface of the support substrate 11.

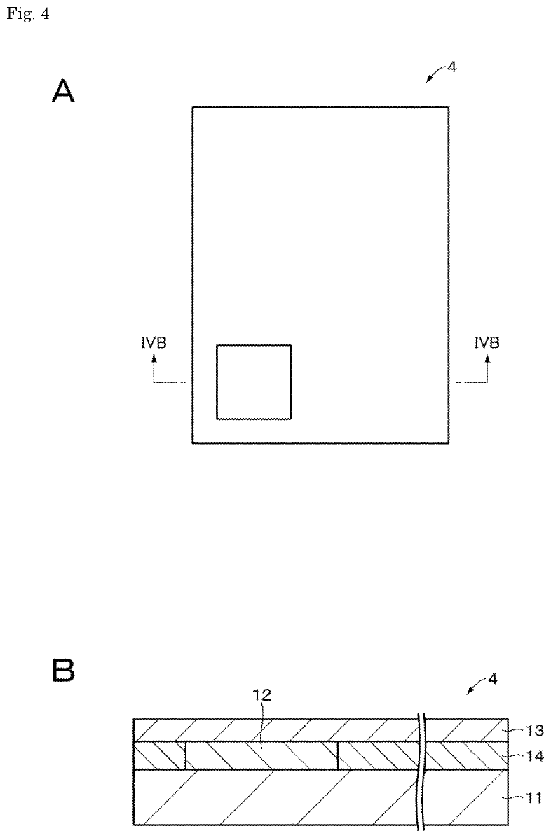

FIG. 4A and FIG. 4B show a first example of a configuration of a recording medium 4 in which the recording layer 12 is provided on a part of one main surface of the support substrate 11. In the first example, the recording medium 4 includes the recording layer 12 and an adhesive layer 14 between the support substrate 11 and the protective layer 13. The adhesive layer 14 is provided to surround the recording layer 12, and the support substrate 11 and the protective layer 13 are bonded together. In this specification, pressure sensitive adhesion is defined as a type of adhesion. According to this definition, the pressure sensitive adhesive layer is considered to be a type of adhesive layer 14.

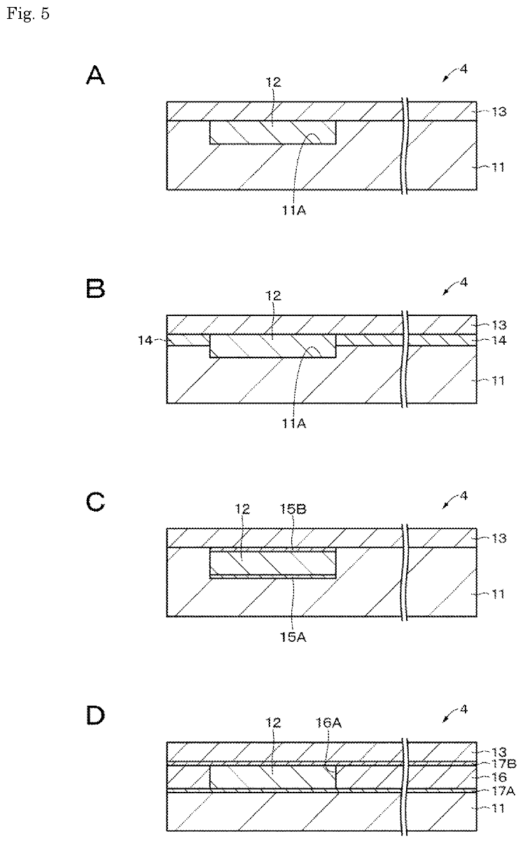

FIG. 5A shows a second example of a configuration of the recording medium 4 in which the recording layer 12 is provided on a part of one main surface of the support substrate 11. In the second example, the support substrate 11 has a recess 11A on one main surface of the support substrate 11, and the recording layer 12 is accommodated in the recess 11A. One main surface of the support substrate 11 is covered with the protective layer 13.

FIG. 5B shows a third example of a configuration of the recording medium 4 in which the recording layer 12 is provided on a part of one main surface of the support substrate 11. In the third example, the support substrate 11 has the recess 11A on one main surface of the support substrate 11, and the recording layer 12 is accommodated in the recess 11A. The recess 11A is thinner than the thickness of the recording layer 12, and the recording layer 12 accommodated in the recess 11A protrudes from one main surface of the support substrate 11. The adhesive layer 14 is provided to surround the recording layer 12 protruding from one main surface of the support substrate 11, and the support substrate 11 and the protective layer 13 are bonded together.

FIG. 5C shows a fourth example of a configuration of the recording medium 4 in which the recording layer 12 is provided on a part of one main surface of the support substrate 11. In the fourth example, the support substrate 11 has the recess 11A on one main surface of the support substrate 11, and the recording layer 12, an adhesive layer 15A and an adhesive layer 15B are accommodated in the recess 11A. The adhesive layer 15A is provided between the bottom of the recess 11A and one main surface of the recording layer 12, and the bottom of the recess 11A and one main surface of the recording layer 12 are bonded together. The adhesive layer 15B is provided between the other main surface of the recording layer 12 and the protective layer 13, and the other main surface of the recording layer 12 and the protective layer 13 are bonded together.

FIG. 5D shows a fifth example of a configuration of the recording medium 4 in which the recording layer 12 is provided on a part of one main surface of the support substrate 11. In the fifth example, the recording medium 4 includes a sheet-like substrate 16 including the recording layer 12, an adhesive layer 17A, and an adhesive layer 17B. The adhesive layer 17A is provided between one main surface of the substrate 16 and one main surface of the support substrate 11, and the substrate 16 and the support substrate 11 are bonded together. The adhesive layer 17B is provided between the other main surface of the substrate 16 and one main surface of the protective layer 13, and the substrate 16 and the protective layer 13 are bonded together. The substrate 16 has a hole 16A, and the recording layer 12 is provided in the hole 16A. However, the configuration of the substrate 16 is not limited thereto, and the substrate 16 has a recess on one main surface or the other main surface of the substrate 16, and the recording layer 12 may be provided in the recess.

As described above, the recording layer 12 is provided on a part of one main surface of the support substrate 11, and thus it is possible to extend the range in which the recording medium 4 is applied. For example, the recording medium 4 can be applied to an Integrated Circuit (IC) card with a photo credit or the like. In this case, the photo part may be composed of the recording layer 12.

Here, in the first to fifth examples, an example in which the recording medium 4 includes the recording layer 12 in the first embodiment has been described, but the recording medium 4 may include the recording layer 21 in the second embodiment in place of the recording layer 12 in the first embodiment, or may include the recording layer 12, the recording layer 21 or the recording layer 31 in Modification Examples 1 and 2.

### Modification Example 4

In the first embodiment and the second embodiment, an example in which the bis(hydroxybenzoic acid) type color-developing agent contains at least one of the compounds represented by Formula (1A) and Formula (1B) has been described, but the bis(hydroxybenzoic acid) type color-developing agent may contain at least one of compounds represented by the following Formula (1C) and Formula (1D). Alternatively, the bis(hydroxybenzoic acid) type color-developing agent may contain at least one of the compounds represented by Formula (1A), Formula (1B), Formula (1C) and Formula (1D):

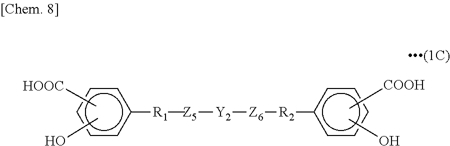

(where, in Formula (1C), Z₅ and Z₆ each independently represent a hydrogen-binding bonding group, Y₂ represents a divalent group, and R₁ and R₂ each independently represent a divalent group)

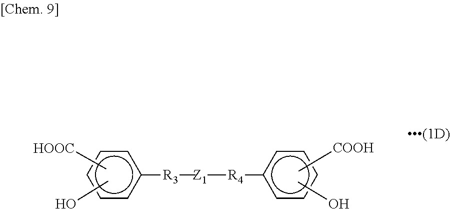

(where, in Formula (1D), Z₇ represents a hydrogen-binding bonding group, and R₃ and R₄ each independently represent a divalent group).

In Formula (1C), Z₅ and Z₆ each independently represent, for example, a urea bond (—NHCONH—), an amide bond (—NHCO—, —OCHN—) or a hydrazide bond (—NHCOCONH—). When Z₅ is an amide bond, a nitrogen atom contained in the amide bond may be bonded to R₁, and a carbon atom contained in the amide bond may be bonded to R₁. When Z₆ is an amide bond, a nitrogen atom contained in the amide bond may be bonded to R₂, and a carbon atom contained in the amide bond may be bonded to R₂.

In Formula (1D), Z₇ represents, for example, a urea bond (—NHCONH—), an amide bond (—NHCO—, —OCHN—) or a hydrazide bond (—NHCOCONH—).

Y₂ in Formula (1C) is the same as Y₁ in Formula (1A).

R₁ and R₂ in Formula (1C) may be a divalent group, and are not particularly limited, and for example, they may be a hydrocarbon group which may have a substituent. Some of carbon atoms of the hydrocarbon group (for example, some of carbon atoms contained in the main chain of the hydrocarbon group) may be substituted with an element such as oxygen (O), sulfur (S) or nitrogen (N). The hydrocarbon group is a general term for groups composed of carbon (C) and hydrogen (H), and may be a saturated hydrocarbon group or an unsaturated hydrocarbon group. Here, the saturated hydrocarbon group is an aliphatic hydrocarbon group having no carbon-carbon multiple bonds, and the unsaturated hydrocarbon group is an aliphatic hydrocarbon group having a carbon-carbon multiple bond (a carbon-carbon double bond or a carbon-carbon triple bond). In addition, the hydrocarbon group may be in the form of a chain or may contain one or two or more rings. The chain form may be a linear form or a branched form having one, two or more side chains or the like. Examples of saturated hydrocarbon groups containing one ring include a phenylene group.

When R₁ and R₂ have a hydrocarbon group, the number of carbon atoms of the hydrocarbon group is, for example, 1 or more and 15 or less, 1 or more and 13 or less, 1 or more and 12 or less, 1 or more and 10 or less, 1 or more and 6 or less or 1 or more and 3 or less.

R₃ and R₄ in Formula (1D) may be a divalent group, and are not particularly limited, and for example, they may be a hydrocarbon group which may have a substituent. Some of carbon atoms of the hydrocarbon group (for example, some of carbon atoms contained in the main chain of the hydrocarbon group) may be substituted with an element such as oxygen (O), sulfur (S) or nitrogen (N). The hydrocarbon group is a general term for groups composed of carbon (C) and hydrogen (H), and may be a saturated hydrocarbon group or an unsaturated hydrocarbon group. Here, the saturated hydrocarbon group is an aliphatic hydrocarbon group having no carbon-carbon multiple bonds, and the unsaturated hydrocarbon group is an aliphatic hydrocarbon group having a carbon-carbon multiple bond (a carbon-carbon double bond or a carbon-carbon triple bond). In addition, the hydrocarbon group may be in the form of a chain or may contain one or two or more rings. The chain form may be a linear form or a branched form having one, two or more side chains or the like.

When R₃ and R₄ have a hydrocarbon group, the number of carbon atoms of the hydrocarbon group is, for example, 1 or more and 15 or less, 1 or more and 13 or less, 1 or more and 12 or less, 1 or more and 10 or less, 1 or more and 6 or less or 1 or more and 3 or less.

More specifically, the bis(hydroxybenzoic acid) type color-developing agent may contain at least one selected from the group consisting of compounds represented by the following Formula (1-20) and Formula (1-21).

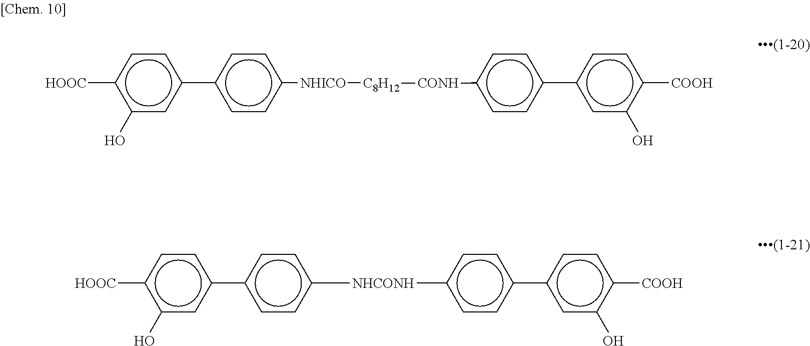

### 4 Application Examples

Next, application examples of the recording mediums 1 to 4 described in the first and second embodiments and Modification Examples 1 to 3 will be described. However, a configuration of an electronic device described below is only an example, and the configuration can be appropriately changed. The recording mediums 1 to 4 can be applied to parts of various electronic devices or clothing items, for example, as so-called wearable terminals, for example, parts of clothing items such as watches (wrist watches), bags, clothes, hats, glasses and shoes, and the types of electronic devices are not particularly limited. In addition, the present invention is not limited to electronic devices and clothing items, but can be applied to, for example, interiors and exteriors such as walls of buildings, exteriors of furniture such as desks, and the like as exterior members. In the following Application Examples 1 to 8, an example in which the recording medium 1 is applied to a card, an electronic device or the like will be described, but any one of the recording mediums 2 to 4 in place of the recording medium 1 can be applied to a card, an electronic device or the like, and a combination of two or more of the recording mediums 1 to 4 can be applied to a card, an electronic device or the like. The color-developing agent used in the recording mediums 1 to 4 may be the color-developing agent in Modification Example 4.

### Application Example 1

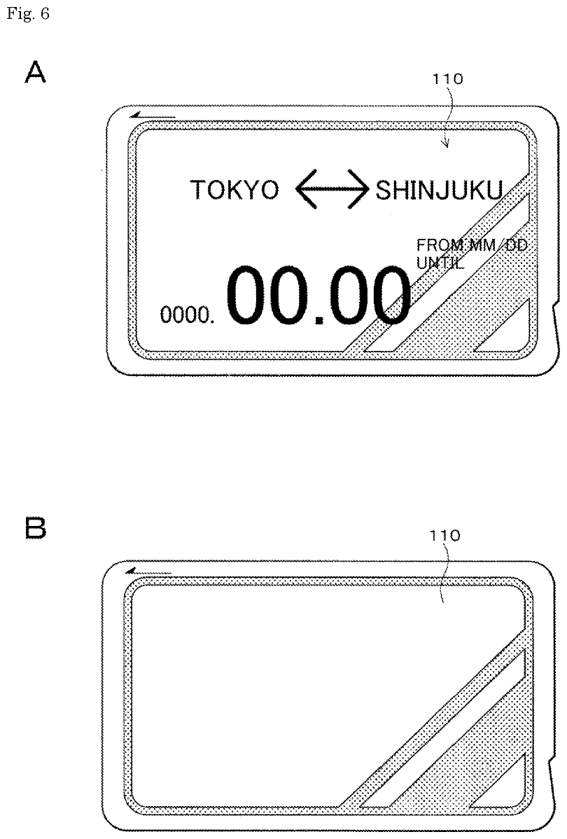

FIG. 6A and FIG. 6B show an appearance of an Integrated Circuit (IC) card with a rewrite function. In this IC card, the surface of the card is a printing surface 110, and for example, a sheet-like recording medium 1 is attached to the IC card. When the recording medium 1 is disposed on the printing surface 110 of the IC card, as shown in FIG. 6A and FIG. 6B, drawing can be appropriately performed on the printing surface 110.

### Application Example 2

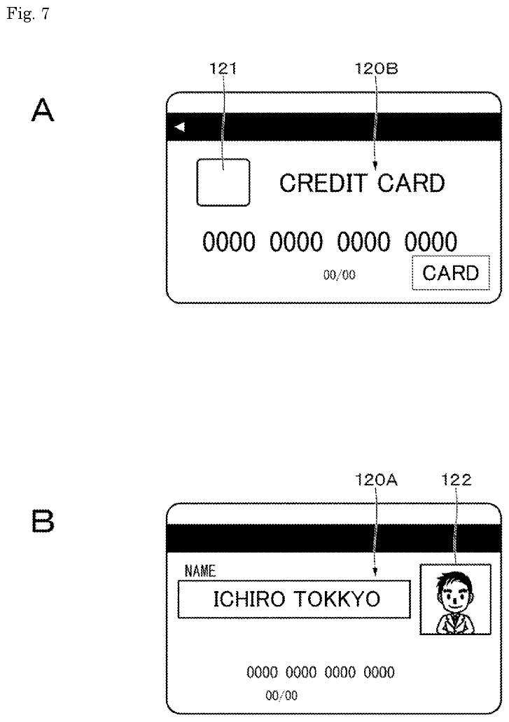

FIG. 7A and FIG. 7B show an appearance of a credit card with an IC chip. The credit card with an IC chip is another example of the IC card. The credit card has an IC chip 121 on a front surface (first surface) 120A, and has a face photo 122 on a back surface (second surface) 120B. When the recording medium 1 is disposed on the front surface (first surface) and the back surface of the credit card, as shown in FIG. 7A and FIG. 7B, drawing can be appropriately performed on the printing surface 110. The face photo 122 may be composed of the recording layers 12, 21, and 31.

### Application Example 3

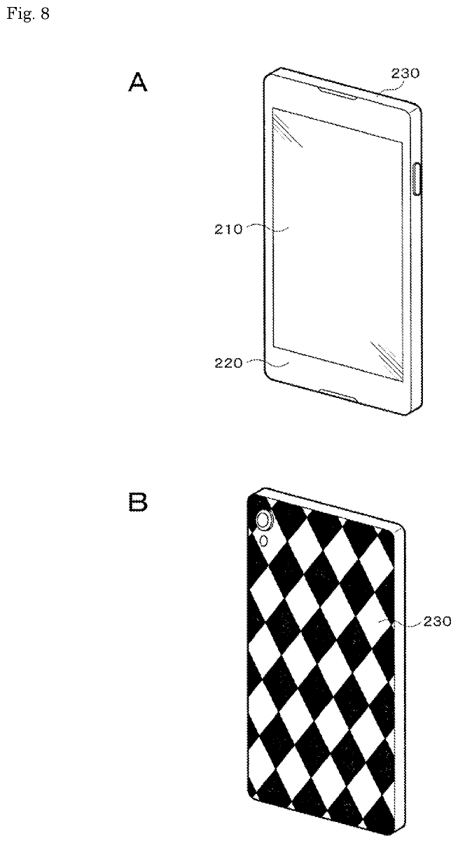

FIG. 8A shows an appearance configuration of a front surface of a smartphone, and FIG. 8B shows an appearance configuration of a rear surface of the smartphone shown in FIG. 8A. This smartphone includes for example, a display unit 210, a non-display unit 220, and a housing 230. For example, on one surface of the housing 230 on the rear surface side, as an exterior member of the housing 230, for example, the recording medium 1 is provided, and thereby various colors and patterns can be displayed as shown in FIG. 8B. Here, while a smartphone is exemplified, the present invention is not limited thereto, and can be applied to, for example, a notebook personal computer (PC), a tablet PC or the like.

### Application Example 4

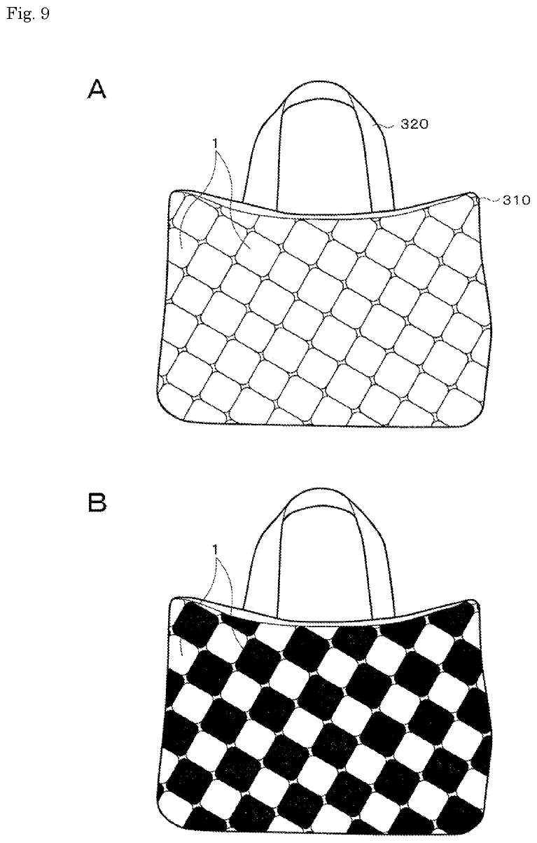

FIG. 9A and FIG. 9B show an appearance of a bag. This bag has, for example, a storage unit 310 and a handle 320, and for example, the recording medium 1 is attached to, for example, the storage unit 310. Various characters and patterns are displayed on the storage unit 310, for example, by the recording medium 1. In addition, when the recording medium 1 is attached to a part of the handle 320, various colors and patterns can be displayed, and the design of the storage unit 310 can be changed from the example of FIG. 9A to the example of FIG. 9B. It is possible to realize electronic devices that are also useful in fashion applications.

### Application Example 5

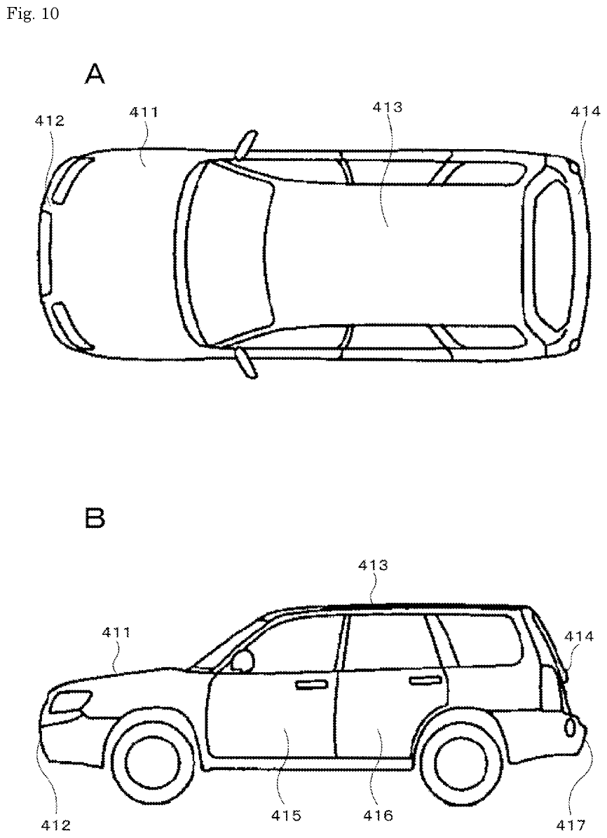

FIG. 10A shows an appearance of an upper surface of an automobile, and FIG. 10B shows an appearance of a side surface of the automobile. As described above, the recording medium 1 of the present disclosure is provided in a vehicle body, for example, a bonnet 411, a bumper 412, a roof 413, a trunk cover 414, a front door 415, a rear door 416 and a rear bumper 417, it is possible to display various types of information and color patterns in each part. In addition, when the recording medium 1 is provided on an interior of the automobile, for example, a handle or a dashboard, various colors and patterns can be displayed.

### Application Example 6

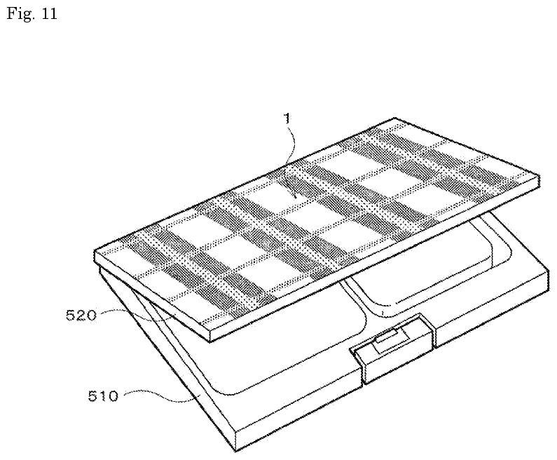

FIG. 11 shows an appearance of a cosmetic container. The cosmetic container includes, for example, an accommodation unit 510 and a lid 520 that covers the accommodation unit 510, and for example, the recording medium 1 is attached to, for example, the lid 520. The lid 520 is decorated with a pattern, a color pattern, characters or the like, for example, as shown in FIG. 11, by the recording medium 1. The pattern, color pattern, characters and the like of the lid 520 can be written by a predetermined drawing device. Here, the recording medium 1 can be attached not only to the front surface (the lid 520) of the cosmetic container but also to the back surface (the accommodation unit 510).

### Application Example 7

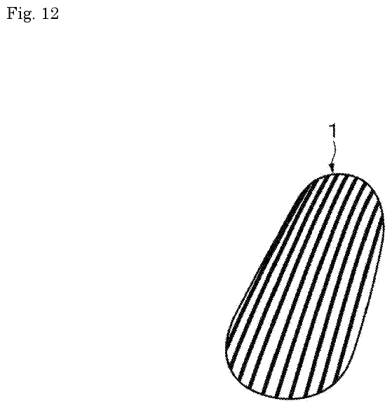

FIG. 12 shows an appearance of a nail chip. The nail chip is an example of the exterior member. The nail chip includes the recording medium 1 on the surface. When the nail chip includes the recording medium 1 on the surface in this manner, various colors and patterns can be displayed. Here, in the above example, a configuration in which the nail chip includes the recording medium 1 on the surface has been described, but the configuration of the nail chip is not limited thereto, and the recording medium 1 itself may be a nail chip. In this case, the support substrate 11 has a claw shape.

### Application Example 8

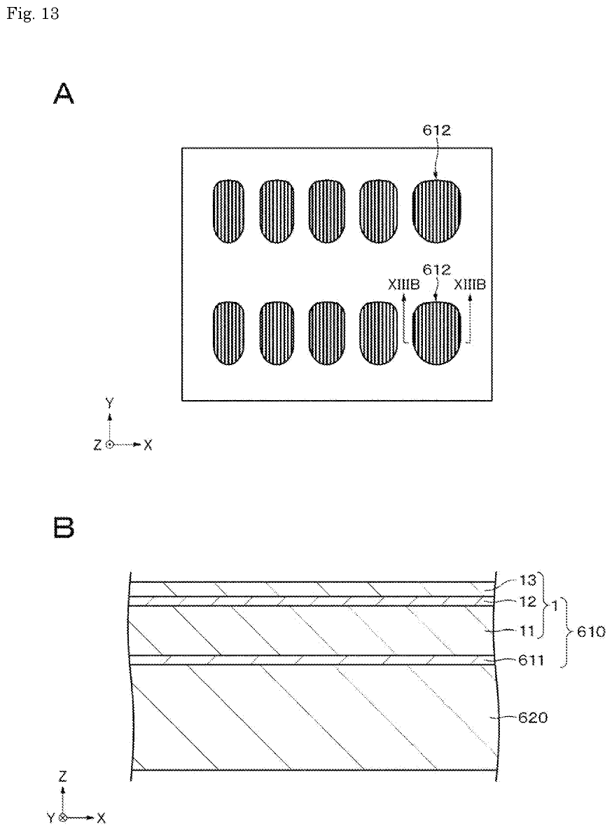

FIG. 13A shows an appearance of a nail seal. FIG. 13B shows a cross section taken along the line XIIIB-XIIIB in FIG. 13A. The nail seal is an example of the exterior member. The nail seal includes a recording medium with a pressure sensitive adhesive layer 610 and a release sheet 620. The recording medium with a pressure sensitive adhesive layer 610 includes the recording medium 1 and a pressure sensitive adhesive layer 611. When the recording medium with a pressure sensitive adhesive layer 610 includes the recording medium 1 in this manner, various colors and patterns can be displayed. The pressure sensitive adhesive layer 611 is provided on the surface of the recording medium 1 on the side of the support substrate 11.

The recording medium 1 and the like have a plurality of nail seal parts 612 that are bonded to claws of fingers of both hands. The nail seal part 612 is held in a cut or semi-cut state with respect to the nail seal, and is peelable at the interface between the pressure sensitive adhesive layer 611 and the release sheet 620.

In Application Example 7 and Application Example 8, an example in which the present disclosure is applied to the nail chip and the nail sheet has been exemplified, but application examples of the present disclosure to nails are not limited thereto. For example, the recording layer 12 and the protective layer 13 may be directly laminated on the natural nail (human body nail) as a support substrate. The recording layer 12 may be formed by applying a coating material to the natural nail and curing it, or may be formed by bonding a separately formed recording layer sheet to the natural nail.

### 5 Examples

Hereinafter, the present disclosure will be described in detail with reference to examples, but the present disclosure is not limited to these examples.

### Examples 1 to 81

### (Process of Preparing Coating Material for Forming Recording Layer)

First, polycarbonate (PC) was dissolved in methyl ethyl ketone (MEK), a color-developing agent was additionally added thereto, and the mixture was dispersed using a rocking mill. As the color-developing agent, as shown in Table 1, different color-developing agents (compounds represented by Formulae (1-1) to (1-8)) were used in Examples 1 to 8. Next, a leuco dye exhibiting the color magenta in a color development state and represented by Formula (2) was added, and finally, the mixture at a ratio (mass ratio) of leuco dye: color-developing agent: polycarbonate=1:2:4 was prepared. In addition, a photothermal conversion material having a phthalocyanine framework was added to prepare a coating material for forming a recording layer. Here, the amount of the photothermal conversion material added was set so that the absorbance during coating was 0.2.

### (Process of Forming Recording Layer)

Next, a coating material for forming a recording layer was applied to a thickness of 3 μm onto a 50 μm-thick PET (support substrate) using a wire bar and dried at 70° C. for 30 minutes to obtain a recording layer. The concentration of the photothermal conversion material contained in the recording layer was set such that an optical density (OD) during color development was 1.5 or more. Next, when laser light was emitted to the recording layer, a colored part and an uncolored part (background) were formed. Accordingly, a desired recording medium was obtained.

### Comparative Example 1

A recording medium was obtained in the same manner as in Example 1 except that a color-developing agent represented by the following Formula (3) was used in place of the color-developing agent represented by Formula (1-1).

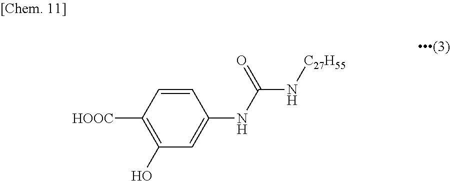

### Comparative Example 2

A recording medium was obtained in the same manner as in Comparative Example 1 except that a vinyl chloride-vinyl acetate copolymer (VC-VAC copolymer) was used in place of the polycarbonate.

### Comparative Example 3

A recording medium was obtained in the same manner as in Comparative Example 2 except that a color-developing agent represented by Formula (1-1) was used in place of the color-developing agent represented by Formula (3).

### Examples 17 to 28

Recoding mediums were obtained in the same manner as in Example 1 except that, as shown in Table 2, color-developing agents (compounds represented by Formulae (1-9) to (1-13), and (1-15) to (1-21)) were used in Examples 17 to 28 in place of the color-developing agent represented by Formula (1-1).

### (Evaluation of Light Resistance)

First, a UV cut barrier was formed on the recording layer of the recording medium obtained as described above and the ODs of the colored part and the uncolored part were then measured. Next, using a xenon weather meter, an accelerated light resistance test (test conditions: room temperature, a radiation illuminance of 60 W/m², and an emission time of 200 hours) was performed for the recording medium, and the ODs of the colored part and the uncolored part of the recording medium were then measured again. Next, for the colored part and the uncolored part, the OD change rate before and after the light resistance test was obtained by the following formula.

(OD change rate before and after light resistance test)[%]=100−(((OD after light resistance test)/(0D before light resistance test))×100)

A sample having an OD change rate of 20% or less before and after the light resistance test was evaluated as “good”, and a sample having an OD change rate of more than 20% before and after the light resistance test was evaluated as “poor”. If the OD change rate before and after the light resistance test is more than 20%, it is said that the rate would be a level at which, generally, anyone can see the change from the original color so that an OD change rate of 20% was set as a reference value for determining good/poor. Table 1 and Table 2 show the results of the light resistance evaluation.

### (Evaluation of Storage Stability)

### Evaluation of Storage Stability in High Temperature Environment

First, the ODs of the colored part and the uncolored part of the recording medium obtained as described above were measured. Next, the recording medium was stored under high temperature conditions of 80° C. and 30% RH for 100 hours, and thus a storage test was performed. In this case, the presence of a UV cut barrier did not matter. The condition of a temperature of 80° C. in the storage test was the highest temperature in the storage test of all parts, and if good results were obtained in the storage test at this temperature, it was thought that the recording medium would be able to withstand storage in various environments. Next, for the colored part and the uncolored part, the OD change rate before and after the storage test was obtained by the following formula.

(OD change rate before and after storage test)[%]=100−(((OD after storage test)/(OD before storage test))×100)

A sample having an OD change rate of 20% or less before and after the storage test was evaluated as “good”, and a sample having an OD change rate of more than 20% before and after the storage test was evaluated as “poor”. The reason why an OD change rate of 20% was set as the reference value for determining good/poor was as described above. Table 1 and Table 2 show the results of the storage stability evaluation.

### Evaluation of Storage Stability in High Temperature and High Humidity Environment

The storage stability of the recording mediums of Examples 1 and 7 in a high temperature and high humidity environment was evaluated as follows. The storage test was performed in the same manner as in the above <Evaluation of Storage Stability in High Temperature Environment> except that the recording medium was stored under high temperature and high humidity conditions of 80° C. and 60% RH for 200 hours, and the OD change rate before and after the storage test was obtained. Subsequently, the storage stability was evaluated in the same manner as in the above <Evaluation of Storage Stability in High Temperature Environment>. Table 4 shows the results of storage stability evaluation.

Table 1 shows the configurations and evaluation results of the recording mediums of Examples 1 to 8 and Comparative Examples 1 to 3.

TABLE 1

| | | | | | Light resistance evaluation | | | | Storage stability (80° C.) | | | |
|---|---|---|---|---|---|---|---|---|---|---|---|---|
| | | | | Photo- | Colored part | | Uncolored part | | Colored part | | Uncolored part | |
| | Color- | | Color- | thermal | OD | Deter- | OD | Deter- | OD | Deter- | OD | Deter- |
| | developing | Matrix | exhibiting | conversion | change | mi- | change | mi- | change | mi- | change | mi- |
| | agent | polymer | compound | material | rate [%] | nation | rate [%] | nation | rate [%] | nation | rate [%] | nation |
| Example 1 | Formula (1-1) | PC | Leuco dye | Photo- | 18 | Good | 18 | Good | 7 | Good | 1 | Good |
| Example 2 | Formula (1-2) | PC | represented | thermal | 19 | Good | 18 | Good | 8 | Good | 3 | Good |
| Example 3 | Formula (1-3) | PC | by Formula | conversion | 16 | Good | 19 | Good | 9 | Good | 2 | Good |
| Example 4 | Formula (1-4) | PC | (2) | material | 16 | Good | 18 | Good | 1 | Good | 0 | Good |
| Example 5 | Formula (1-5) | PC | | having a | 15 | Good | 19 | Good | 9 | Good | 1 | Good |
| Example 6 | Formula (1-6) | PC | | phthalo- | 16 | Good | 19 | Good | 3 | Good | 0 | Good |
| Example 7 | Formula (1-7) | PC | | cyanine | 15 | Good | 17 | Good | 7 | Good | 3 | Good |
| Example 8 | Formula (1-8) | PC | | framework | 19 | Good | 18 | Good | 12 | Good | 1 | Good |
| Compar- | Formula (3) | PC | | | 15 | Good | 19 | Good | 85 | Poor | 1 | Good |
| ative | | | | | | | | | | | | |
| Example 1 | | | | | | | | | | | | |
| Compar- | Formula (3) | VC- | | | 19 | Good | 50 or | Poor | 87 | Poor | 50 or | Poor |
| ative | | VAC | | | | | more | | | | more | |
| Example 2 | | co- | | | | | | | | | | |
| | | polymer | | | | | | | | | | |
| Compar- | Formula (1-1) | VC- | | | 19 | Good | 50 or | Poor | 9 | Good | 3 | Good |
| ative | | VAC | | | | | more | | | | | |
| Example 3 | | co- | | | | | | | | | | |
| | | polymer | | | | | | | | | | |

SYP334094WO01
PC: polycarbonate
VC-VAC copolymer: vinyl chloride-vinyl acetate copolymer
Here, also in the following Tables 2 to 4, 6, and 7, the abbreviation “PC” indicates polycarbonate.

Table 2 shows the configurations and evaluation results of the recording mediums of Examples 17 to 28.

TABLE 2

| | | | | | Light resistance evaluation | | | | Storage stability (80° C.) | | | |
|---|---|---|---|---|---|---|---|---|---|---|---|---|
| | | | | Photo- | Colored part | | Uncolored part | | Colored part | | Uncolored part | |
| | Color- | | Color- | thermal | OD | Deter- | OD | Deter- | OD | Deter- | OD | Deter- |
| | developing | Matrix | exhibiting | conversion | change | mi- | change | mi- | change | mi- | change | mi- |
| | agent | polymer | compound | material | rate [%] | nation | rate [%] | nation | rate [%] | nation | rate [%] | nation |
| Example 17 | Formula (1-9) | PC | Leuco dye | Photothermal | 18 | Good | 18 | Good | 10 | Good | 3 | Good |
| Example 18 | Formula (1-10) | PC | represented | conversion | 19 | Good | 18 | Good | 19 | Good | 1 | Good |
| Example 19 | Formula (1-11) | PC | by Formula | material | 18 | Good | 19 | Good | 20 | Good | 1 | Good |
| Example 20 | Formula (1-12) | PC | (2) | having a | 18 | Good | 18 | Good | 20 | Good | 10 | Good |
| Example 21 | Formula (1-13) | PC | | phthalo- | 16 | Good | 19 | Good | 1 | Good | 9 | Good |
| Example 22 | Formula (1-15) | PC | | cyanine | 16 | Good | 18 | Good | 1 | Good | 9 | Good |
| Example 23 | Formula (1-16) | PC | | framework | 19 | Good | 18 | Good | 1 | Good | 13 | Good |
| Example 24 | Formula (1-17) | PC | | | 18 | Good | 19 | Good | 3 | Good | 6 | Good |
| Example 25 | Formula (1-18) | PC | | | 18 | Good | 18 | Good | 1 | Good | 1 | Good |
| Example 26 | Formula (1-19) | PC | | | 18 | Good | 18 | Good | 3 | Good | 2 | Good |
| Example 27 | Formula (1-20) | PC | | | 18 | Good | 19 | Good | 3 | Good | 15 | Good |
| Example 28 | Formula (1-21) | PC | | | 18 | Good | 19 | Good | 5 | Good | 4 | Good |

Table 3 shows compounds represented by Formula (1A) and in which Z₁ and Z₂ represent an amid group and Y₁ represents a normal alkyl chain, which are extracted from Table 1 and Table 2.

TABLE 3

| | | | Number | | | | | | | |
|---|---|---|---|---|---|---|---|---|---|---|
| | | | of carbon | | | | Storage stability (80° C.) | | | |
| | | | atoms | | | Photo- | Colored part | | Uncolored part | |
| | Color- | | of Y₁ | | Color- | thermal | OD | Deter- | OD | Deter- |
| | developing | | (alkyl | Matrix | exhibiting | conversion | change | mi- | change | mi- |
| | agent | Z₁ and Z₂ | chain) | polymer | compound | agent | rate [%] | nation | rate [%] | nation |
| Example 18 | Formula (1-10) | Amid | 9 | PC | Leuco dye | Photothermal | 19 | Good | 1 | Good |
| Example 19 | Formula (1-11) | bond | 8 | PC | represented by | conversion | 20 | Good | 1 | Good |
| Example 20 | Formula (1-12) | | 7 | PC | Formula (2) | material having a | 20 | Good | 10 | Good |
| Example 7 | Formula (1-7) | | 6 | PC | | phthalocyanine | 7 | Good | 3 | Good |
| Example 21 | Formula (1-13) | | 5 | PC | | framework | 1 | Good | 9 | Good |
| Example 22 | Formula (1-15) | | 1 | PC | | | 1 | Good | 9 | Good |

Table 4 shows the configurations and the evaluation results (evaluation of the storage stability in the high temperature and high humidity environment) of the recording mediums of Examples 1 and 7.

TABLE 4

| | | | | | | Storage stability (80° C., 60% RH) | | | |
|---|---|---|---|---|---|---|---|---|---|
| | | | | | Photo- | Colored part | | Uncolored part | |
| | Color- | | | Color- | thermal | OD | Deter- | OD | Deter- |
| | developing | | Matrix | exhibiting | conversion | change | mi- | change | mi- |
| | agent | Z₁ and Z₂ | polymer | compound | agent | rate [%] | nation | rate [%] | nation |
| Example 1 | (1-1) | Urea bond | PC | Leuco dye | Photothermal | 6 | Good | 3 | Good |
| Example 7 | (1-7) | Amid bond | PC | represented by | conversion | 53 | Poor | 5 | Good |
| | | | | Formula (2) | material having a | | | | |
| | | | | | phthalocyanine | | | | |
| | | | | | framework | | | | |

The following can be understood from Table 1.

When a compound represented by any of Formulae (1-1) to (1-8) was used as the color-developing agent and a polycarbonate resin was used as the matrix polymer, it was possible to improve the light resistance of the colored part and the uncolored part (background). In addition, it was possible to improve the storage stability of the colored part and the uncolored part (background) (refer to Examples 1 to 8).

When a polycarbonate resin was used as the matrix polymer but a compound represented by any of Formulae (1-1) to (1-8) was not used as the color-developing agent, the storage stability of the colored part decreased (refer to Comparative Example 1).

When a compound represented by any of Formulae (1-1) to (1-8) was used as the color-developing agent, but a polycarbonate resin was not used as the matrix polymer, the light resistance of the uncolored part (background) decreased (refer to Comparative Example 3).

When a compound represented by any of Formulae (1-1) to (1-8) was not used as the color-developing agent and a polycarbonate resin was not used as the matrix polymer, the light resistance of the uncolored part (background) decreased. In addition, the storage stability of the colored part and the uncolored part decreased (refer to Comparative Example 2).

The following can be understood from Table 2.

Also in the recording medium in which a bis(3-hydroxybenzoic acid) type compound was used as the color-developing agent, the same effects as in the recording medium in which a bis(2-hydroxybenzoic acid) type compound was used as the color-developing agent were obtained (refer to Example 17 (color-developing agent: Formula (1-9))).

In the recording medium in which a compound of Formula (1A) in which Z₁ and Z₂ represents an amid group, and Y₁ represents an alkyl chain having a branch part was used as the color-developing agent, better high temperature storage characteristics on average were obtained compared to the recording mediums in which a compound in which Z₁ and Z₂ represent an amid group, and Y₁ represents a normal alkyl chain was used as the color-developing agent (refer to Examples 24 to 26 (color-developing agent: Formulae (1-17) to (1-19))). In the recording medium in which a compound of Formula (1A) in which Z₁ and Z₂ represent a urea group was used as the color-developing agent, it was possible to improve high temperature storage characteristics of the colored part compared to the recording medium in which a compound of Formula (1A) in which Z₁ and Z₂ represent an amid group was used as the color-developing agent (refer to Examples 19 and 23 (color-developing agent: Formulae (1-11) and (1-16))). Also in the recording medium in which a compound of Formula (1C) in which R₁ and R₂ represent a phenylene group was used as the color-developing agent and the recording medium in which a compound of Formula (1D) in which R₃ and R₄ represent a phenylene group was used as the color-developing agent, the same effects as in the recording medium in which a compound of Formula (1A) or Formula (1B) was used were obtained (refer to Examples 27 and 28 (color-developing agent: Formulae (1-20) and (1-21))).

The following can be understood from Table 3.

In the recording medium in which a compound of Formula (1A) in which Z₁ and Z₂ represent an amid group, and Y₁ represents a normal alkyl chain was used as the color-developing agent, it was possible to improve the high-temperature storage stability of the colored part and the uncolored part regardless of the length of the normal alkyl chain. If the number of carbon atoms of the normal alkyl chain was 6 or less, it was possible to further improve the storage stability of the colored part (refer to Examples 7, 21, and 22), and if the number of carbon atoms of the normal alkyl chain was an odd number of 5 or less, it was possible to further improve the high-temperature storage stability of the colored part (refer to Examples 21 and 22).

The following can be understood from Table 4.

In the recording medium in which a compound of Formula (1A) in which Z₁ and Z₂ represent a urea bond was used as the color-developing agent, it was possible to improve high temperature high humidity storage characteristics of the colored part compared to the recording medium in which a compound of Formula (1A) in which Z₁ and Z₂ represent an amide bond was used as the color-developing agent.

### Examples 9 to 16 and Comparative Example 4

### (Process of Preparing Coating Material for Forming First Recording Layer)

Coating materials for forming a first recording layer were prepared in the same manner as in Examples 1 to 8 and Comparative Example 1 except that a leuco dye exhibiting the color cyan in a color development state was used in place of a leuco dye exhibiting the color magenta in a color development state.

### (Process of Preparing Coating Material for Forming Second Recording Layer)

Coating materials for forming a second recording layer were prepared in the same manner as in Examples 1 to 8 and Comparative Example 1.

### (Process of Preparing Coating Material for Forming Third Recording Layer)

Coating materials for forming a third recording layer were prepared in the same manner as in Examples 1 to 8 and Comparative Example 1 except that a leuco dye exhibiting the color yellow in a color development state was used in place of a leuco dye exhibiting the color magenta in a color development state.

### (Process of Forming First to Third Recording Layers)

Next, a coating material for forming a first recording layer was applied to a thickness of 3 μm onto a 50 μm-thick PET (support substrate) using a wire bar and dried at 70° C. for 30 minutes to obtain a first recording layer (cyan layer). Subsequently, a polyvinyl alcohol aqueous solution was applied to the first recording layer and dried to form an insulation layer having a film thickness of 20 μm.

Next, a coating material for forming a second recording layer was applied to a thickness of 3 μm onto the insulation layer using a wire bar and dried at 70° C. for 30 minutes to obtain a second recording layer (magenta layer). Subsequently, a polyvinyl alcohol aqueous solution was applied onto the second recording layer and dried to form an insulation layer having a film thickness of 20 μm.

Next, a coating material for forming a third recording layer was applied to a thickness of 3 μm onto the insulation layer using a wire bar and dried at 70° C. for 30 minutes to obtain a third recording layer (yellow layer). Accordingly, a desired recording medium was obtained.

### Examples 29 to 41

### (Process of Preparing Coating Material for Forming First Recording Layer)

A leuco dye exhibiting the color cyan in a color development state was used in place of a leuco dye exhibiting the color magenta in a color development state. In addition, in place of the color-developing agent represented by Formula (1-1), as shown in Table 7, different color-developing agents (compounds represented by Formulae (1-9) to (1-21)) were used in Examples 29 to 41. Except for the above, coating materials for forming a first recording layer were prepared in the same manner as in Example 1.

### (Process of Preparing Coating Material for Forming Second Recording Layer)

Coating materials for forming a second recording layer were prepared in the same manner as in the process of preparing a coating material for forming a first recording layer except that a leuco dye exhibiting the color magenta in a color development state was used in place of a leuco dye exhibiting the color cyan in a color development state.

### (Process of Preparing Coating Material for Forming Third Recording Layer)

Coating materials for forming a third recording layer were prepared in the same manner as in the process of preparing a coating material for forming a first recording layer except that a leuco dye exhibiting the color yellow in a color development state was used in place of a leuco dye exhibiting the color cyan in a color development state.

### (Process of Forming First to Third Recording Layers)

As in Examples 9 to 16, a first recording layer (cyan layer), a second recording layer (magenta layer), and a third recording layer (yellow layer) were sequentially formed on a 50 μm-thick PET (support substrate). Accordingly, a desired recording medium was obtained.

### (Evaluation of Heat Resistance)

First, the recording medium obtained as described above was cut into 3 cm squares to form an evaluation sample. Next, the spectrum was acquired using a spectrophotometer (V-770 commercially available from JASCO Corporation) (measurement mode: integrating sphere mode, transparent mode), and the average transmittance T_{B} of the evaluation sample in a wavelength band of 1,000 nm or more and 1,100 nm or less was calculated. Next, the evaluation sample was pressed on a metal plate set at a temperature of 150° C. under a certain pressure of 0.5 Mpa for 5 minutes. Here, the temperature of 150° C. was a temperature of the surface of the metal plate during pressing. Next, the spectrum was acquired using the spectrophotometer (measurement mode: integrating sphere mode, transparent mode), and the average transmittance T_{A} of the evaluation sample in a wavelength band of 1,000 nm or more and 1,100 nm or less was calculated. Next, the difference ΔT (=T_{B}−T_{A}) between the average transmittance T_{B} before heating press and the average transmittance T_{A} after heating press was calculated. Table 6 and Table 7 show the results of heat resistance evaluation (calculation result of difference ΔT).

The measurement conditions of the spectrophotometer are as shown in the following Table 5.

TABLE 5

| | |
|---|---|
| Measurement range | 1,100 to 380 nm |
| Data acquisition interval | 2 nm |
| UV/Vis bandwidth | 5.0 nm |
| NIR bandwidth | 20.0 nm |
| UV/Vis response | 0.06 sec |
| NIR response | 0.06 sec |
| Scanning speed | 1,000 nm/min |
| Light source switching | 340 nm |
| Diffraction grating switching | 850 nm |
| Light source | D2/WI |
| Filter switching | Step |
| Correction | Baseline |

Here, the heat resistance was evaluated based on the transmittance change in a wavelength band of 1,000 nm or more and 1,100 nm or less rather than the transmittance change in a visible light range, and the reason for this is as follows. That is, there is a possibility of the leuco dye contained in the recording layer developing a color due to light emitted from a light source of the spectrophotometer and the transmittance in the visible light range changing. In order to exclude the change in transmittance due to factors other than such heating press, the heat resistance was evaluated with a transmittance in a wavelength band of 1,000 nm or more and 1,100 nm or less.

Table 6 shows the configurations and evaluation results of the recording mediums of Examples 9 to 16 and Comparative Example 4.

TABLE 6

| | Color-developing | Matrix | Difference |
|---|---|---|---|
| | agent | polymer | ΔT |
| Example 9 | Formula (1-1) | PC | 0.2 |
| Example 10 | Formula (1-2) | | 0.3 |
| Example 11 | Formula (1-3) | | 0.2 |
| Example 12 | Formula (1-4) | | 0.2 |
| Example 13 | Formula (1-5) | | 0.6 |
| Example 14 | Formula (1-6) | | 0.4 |
| Example 15 | Formula (1-7) | | 0.2 |
| Example 16 | Formula (1-8) | | 0.3 |
| Comparative | Formula (3) | | 1.1 |
| Example 4 | | | |

PC: polycarbonate

Table 7 shows the configurations and evaluation results of the recording mediums of Examples 29 to 41.

TABLE 7

| | Color-developing | Matrix | Difference |
|---|---|---|---|
| | agent | polymer | ΔT |
| Example 29 | Formula (1-9) | PC | 0.3 |
| Example 30 | Formula (1-10) | | 0.3 |
| Example 31 | Formula (1-11) | | 0.4 |
| Example 32 | Formula (1-12) | | 0.2 |
| Example 33 | Formula (1-13) | | 0.3 |
| Example 34 | Formula (1-14) | | 0.2 |
| Example 35 | Formula (1-15) | | 0.2 |
| Example 36 | Formula (1-16) | | 0.3 |
| Example 37 | Formula (1-17) | | 0.3 |
| Example 38 | Formula (1-18) | | 0.2 |
| Example 39 | Formula (1-19) | | 0.2 |
| Example 40 | Formula (1-20) | | 0.3 |
| Example 41 | Formula (1-21) | | 0.3 |

The following can be understood from Table 6.

When a compound represented by any of Formulae (1-1) to (1-8) was used as the color-developing agent and a polycarbonate resin was used as the matrix polymer, the transmittance change before and after heating press (difference ΔT) could be 1.0 or less. Therefore, it was possible to realize the recording medium that can withstand high-temperature pressing. That is, it was possible to minimize the change in display quality due to high-temperature pressing.

The following can be understood from Table 7.

Even when a compound represented by any of Formulae (1-9) to (1-21) was used as the color-developing agent and a polycarbonate resin was used as the matrix polymer, the transmittance change before and after heating press (difference ΔT) could be 1.0 or less. Therefore, it was possible to realize the recording medium that can withstand high-temperature pressing. That is, it was possible to minimize the change in display quality due to high-temperature pressing.

While embodiments and modification examples of the present disclosure have been described above in detail, the present disclosure is not limited to the above embodiments and modification examples, and various modifications based on the technical idea of the present disclosure can be made.

For example, the configurations, methods, processes, shapes, materials, numerical values and the like exemplified in the above embodiments and modification examples are only examples, and as necessary, different configurations, methods, processes, shapes, materials, numerical values and the like may be used. The configurations, methods, processes, shapes, materials, numerical values and the like of the above embodiments and modification examples can be combined with each other as long as they do not deviate from the gist of the present disclosure.

In the numerical ranges stated in stages in the above embodiments and modification examples, the upper limit value or the lower limit value of the numerical ranges of a certain stage may be replaced with the upper limit value or the lower limit value in the numerical range of another stage. Unless otherwise specified, the materials exemplified in the above embodiments and modification examples may be used alone or two or more thereof may be used in combination.

In addition, the present disclosure may have the following configurations.

(1) A recording medium, including:

a support substrate; and

a recording layer provided on the support substrate,

wherein the recording layer contains

a color exhibiting compound having an electron-donating property,

a color-developing agent having an electron-accepting property, and

a matrix polymer,

wherein the color-developing agent contains at least one of compounds represented by the following Formula (1A) and Formula (1B), and wherein the matrix polymer contains a polycarbonate resin:

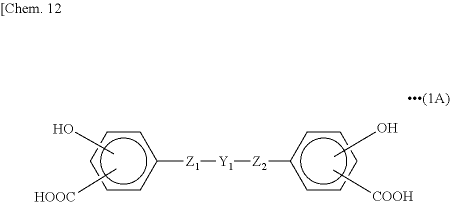

(where, in Formula (1A), Z₁ and Z₂ each independently represent a hydrogen-binding bonding group, and Y₁ represents a divalent group)

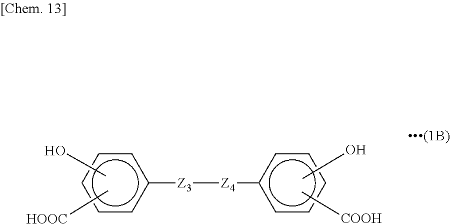

(where, in Formula (1B), Z₃ and Z₄ each independently represent a hydrogen-binding bonding group).

(2) The recording medium according to (1),

wherein a difference ΔT=T_{B}−T_{A} between a transmittance T_{A} of the recording medium obtained after heating press at 150° C. and a transmittance T_{B} of the recording medium obtained before the heating press (where, the transmittances T_{A} and T_{B} are average transmittances in a wavelength band range of 1,000 nm or more and 1,100 nm or less) is 1.0% or less.

(3) The recording medium according to (2),

wherein the difference ΔT is 0.6% or less.

(4) The recording medium according to any one of (1) to (3),

wherein the recording layer includes a first layer to an nth layer containing color-exhibiting compounds having different color development hues.

(5) The recording medium according to any one of (1) to (3),

wherein the recording layer includes

a first layer containing a color-exhibiting compound that exhibits the color cyan in a color development state,

a second layer containing a color-exhibiting compound that exhibits the color magenta in a color development state, and

a third layer containing a color-exhibiting compound that exhibits the color yellow in a color development state.

(6) The recording medium according to any one of (1) to (5), wherein, in Formula (1A), Z₁ and Z₂ each independently represent a urea bond (—NHCONH—), an amide bond (—NHCO—, —OCHN—) or a hydrazide bond (—NHCOCONH—).

(7) The recording medium according to any one of (1) to (6), wherein, in Formula (1A), Y₁ is a chain hydrocarbon group which may have a substituent.

(8) The recording medium according to any one of (1) to (6), wherein, in Formula (1A), Y₁ is a normal alkyl chain.

(9) The recording medium according to (8), wherein the number of carbon atoms of the normal alkyl chain is 6 or less.

(10) The recording medium according to any one of (1) to (9), wherein the recording layer further contains a photothermal conversion material.

(11) The recording medium according to any one of (1) to (10), wherein the recording layer has a configuration in which a coloring state is able to be changed by an external stimulus.

(12) The recording medium according to any one of (1) to (11), further including: a protective layer provided on the recording layer; and an adhesive layer that bonds the support substrate and the protective layer together.

(13) The recording medium according to any one of (1) to (11), further including

a protective layer provided on the recording layer,

wherein the support substrate has a recess, and

wherein the recording layer is accommodated in the recess.

(14) The recording medium according to any one of (1) to (11), further including: a protective layer provided on the recording layer; and

an adhesive layer that bonds the support substrate and the protective layer together,

wherein the support substrate has a recess, and

wherein the recording layer is accommodated in the recess.

(15) An exterior member, including the recording medium according to any one of (1) to (14).

(16) A recording medium, including:

a support substrate; and

a recording layer provided on the support substrate,

wherein the recording layer contains

a color exhibiting compound having an electron-donating property,

a color-developing agent having an electron-accepting property, and

a matrix polymer,

wherein the color-developing agent contains at least one of compounds represented by the following Formula (1C) and Formula (1D), and

wherein the matrix polymer contains a polycarbonate resin:

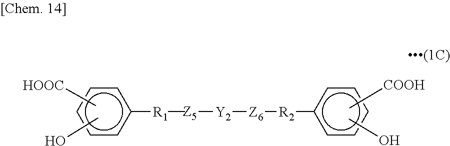

(where, in Formula (1C), Z₅ and Z₆ each independently represent a hydrogen-binding bonding group, Y₂ represents a divalent group, and R₁ and R₂ each independently represent a divalent group)

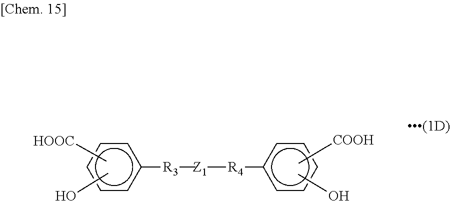

(where, in Formula (1D), Z₇ represents a hydrogen-binding bonding group, and R₃ and R₄ each independently represent a divalent group).

### REFERENCE SIGNS LIST

1, 2, 3, 4 Recording medium
11 Support substrate
11A Recess
12, 21, 31 Recording layer
13 Protective layer
14, 15A, 15B, 17A, 17B Adhesive layer
16 Substrate
16A Hole
22 First layer
23 Second layer
24 Third layer
25, 26 Insulation layer
31C, 31M, 31Y Microcapsule
110 Printing surface
120A Front surface
120B Back surface
121 IC chip
122 Face photo
210 Display unit
220 Non-display unit
230 Housing
310 Storage unit
320 Handle
411 Bonnet
412 Bumper
413 Roof
414 Trunk cover
415 Front door
416 Rear door
417 Rear bumper
510 Accommodation unit
520 Lid
610 Recording medium with pressure sensitive adhesive layer
611 Pressure sensitive adhesive layer
612 Nail seal part
620 Release sheet

1. A recording medium, comprising:
a support substrate; and
a recording layer provided on the support substrate,
wherein the recording layer contains
a color exhibiting compound having an electron-donating property,
a color-developing agent having an electron-accepting property, and
a matrix polymer,
wherein the color-developing agent contains at least one of compounds represented by the following Formula (1A) and Formula (1B), and
wherein the matrix polymer contains a polycarbonate resin: 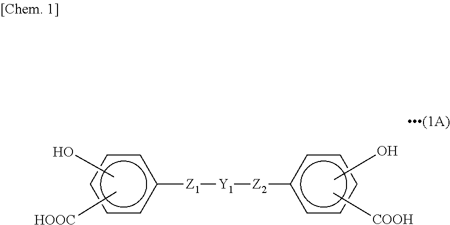
(where, in Formula (1A), Z₁ and Z₂ each independently represent a hydrogen-binding bonding group, and Y₁ represents a divalent group) 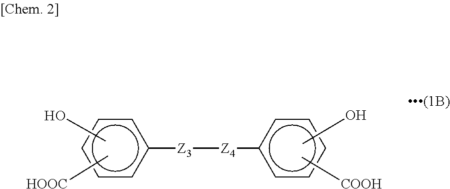
(where, in Formula (1B), Z₃ and Z₄ each independently represent a hydrogen-binding bonding group).

2. The recording medium according to claim 1,
wherein a difference ΔT=T_{B}−T_{A} between a transmittance T_{A} of the recording medium obtained after heating press at 150° C. and a transmittance T_{B} of the recording medium obtained before the heating press (where, the transmittances T_{A} and T_{B} are average transmittances in a wavelength band range of 1,000 nm or more and 1,100 nm or less) is 1.0% or less.

3. The recording medium according to claim 2,
wherein the difference ΔT is 0.6% or less.

4. The recording medium according to claim 1,
wherein the recording layer includes a first layer to an nth layer containing color-exhibiting compounds having different color development hues.

5. The recording medium according to claim 1,
wherein the recording layer includes
a first layer containing a color-exhibiting compound that exhibits the color cyan in a color development state,
a second layer containing a color-exhibiting compound that exhibits the color magenta in a color development state, and
a third layer containing a color-exhibiting compound that exhibits the color yellow in a color development state.

6. The recording medium according to claim 1,
wherein, in Formula (1A), Z₁ and Z₂ each independently represent a urea bond (—NHCONH—), an amide bond (—NHCO—, —OCHN—) or a hydrazide bond (—NHCOCONH—).

7. The recording medium according to claim 1,
wherein, in Formula (1A), Y₁ is a chain hydrocarbon group which may have a substituent.

8. The recording medium according to claim 1,
wherein, in Formula (1A), Y₁ is a normal alkyl chain.

9. The recording medium according to claim 8,
wherein the number of carbon atoms of the normal alkyl chain is 6 or less.

10. The recording medium according to claim 1,
wherein the recording layer further contains a photothermal conversion material.

11. The recording medium according to claim 1,
wherein the recording layer has a configuration in which a coloring state is able to be changed by an external stimulus.

12. The recording medium according to claim 1, further comprising:
a protective layer provided on the recording layer; and
an adhesive layer that bonds the support substrate and the protective layer together.

13. The recording medium according to claim 1, further comprising
a protective layer provided on the recording layer,
wherein the support substrate has a recess, and
wherein the recording layer is accommodated in the recess.

14. The recording medium according to claim 1, further comprising:
a protective layer provided on the recording layer; and
an adhesive layer that bonds the support substrate and the protective layer together,
wherein the support substrate has a recess, and
wherein the recording layer is accommodated in the recess.

15. An exterior member, comprising the recording medium according to claim 1.
